(19) United States
(12) Patent Application Publication
(10) Pub. No.: US 2021/0340295 A1
(43) Pub. Date: Nov. 4, 2021

(54) PROCESS FOR END FUNCTIONALIZED ACRYLIC OLIGOMERS VIA HIGH TEMPERATURE POLYMERIZATION AND EFFICIENT ADDITION REACTIONS

(71) Applicant: BASF SE, Ludwighafen am Rhein (DE)

(72) Inventors: Pirro CIPI, Wyandotte, MI (US); Mary THOMSON, Ludwigshafen (DE); Libor SEDA, Karlovy Vary (CZ); Timothy KLOTS, Wyandotte, MI (US); Jon DEBLING, Whitehouse, OH (US)

(21) Appl. No.: 17/259,854

(22) PCT Filed: Jul. 12, 2019
(86) PCT No.: PCT/EP2019/068856

§ 371 Date: Jan. 12, 2021

Related U.S. Application Data
(60) Provisional application No. 62/697,211, filed on Jul. 12, 2018.

(51) Int. Cl. C08F 220/12; C09D 11/107

(52) U.S. Cl. CPC C08F 220/12; C09D 11/107

(57) ABSTRACT

An oligomeric resin adduct, compositions comprising the oligomeric resinadduct, and process for making oligomeric resin adduct, wherein the the process includes charging into a reactor a mixture including a vinylic monomer that includes a styrenic monomer, a (meth)acrylic monomer, or a mixture thereof; a polymerization initiator; and optionally a reaction solvent; maintaining the reactor at a temperature sufficient to produce an oligomeric resin from the vinylic monomer; maintaining the vinylic monomer, the polymerization initiator, and optionally the reaction solvent at a sufficient amount to produce the oligomeric resin, wherein the oligomeric resin contains at least one terminal olefinic unsaturation; and reacting the oligomeric resin with a compound of Formula I, Formula II, or a mixture thereof as defined herein.

### FIELD

The present technology generally relates to end functionalized styrenic and/or (meth)acrylic oligomers and processes for producing the same.

### SUMMARY

The present technology provides a process for producing an oligomeric resin adduct, the process including: charging into a reactor a mixture including a vinylic monomer that includes a styrenic monomer, a (meth)acrylic monomer, or a mixture thereof; a polymerization initiator; and optionally a reaction solvent; maintaining the reactor at a temperature sufficient to produce an oligomeric resin from the vinylic monomer, wherein the oligomeric resin contains at least one terminal olefinic unsaturation; and reacting the oligomeric resin with a compound of Formula I, Formula II, or a mixture thereof as defined herein. In some embodiments, the reactor may be charged continuously with the mixture. In this embodiment, the vinylic monomer, the polymerization initiator, and optionally the reaction solvent are maintained at a sufficient amount to produce the oligomeric resin. The present technology also provides an oligomeric resin adduct of the process provided herein.

In another aspect the present technology provides an oligomeric resin adduct including an oligomeric resin comprising polymerized vinylic monomer that includes a styrenic monomer, a (meth)acrylic monomer, or a mixture thereof; wherein at least one terminal olefin unsaturation of the oligomeric resin has been reacted with a compound of Formula I, Formula II, or a mixture thereof as defined herein.

In some embodiments, the oligomeric resin may include about 20 wt % to about 95 wt % of the polymerized vinylic monomer. In some embodiments, the oligomeric resin may be isolated prior to reacting the oligomeric resin with a compound of Formula I, Formula II, or a mixture thereof. In some embodiments, the oligomeric resin adduct may be isolated.

The oligomeric resin adducts and compositions thereof may have highly desired lower viscosity and lower viscosity range, provide effective pigment dispersion, and/or provide uniform films when cured.

### BRIEF DESCRIPTION OF THE DRAWINGS

FIG. 1 is a graph illustrating the effect of temperature and acrylate/methacrylate ratio on acrylic acid copolymers terminal double bond (“TBD”) concentration, according to Example 2.

FIG. 2 is a graph illustrating the effect of temperature and acrylate/methacrylate ratio on acrylic acid copolymers polydispersity, according to Example 2.

FIG. 3 is a graph illustrating the effect of temperature and acrylate/methacrylate ratio on hydroxyethyl acrylate copolymers TBD concentration, according to Example 3.

FIG. 4 is a graph illustrating the effect of temperature and acrylate/methacrylate ratio on hydroxyethyl acrylate copolymers polydispersity, according to Example 3.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and may be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, the number average molecular weight (Mₙ) is the statistical average molecular weight of all the polymer chains in the polymer and is defined by:

Mₙ=(ΣNᵢMᵢ)/ΣNᵢ,

where Mᵢ is the molecular weight of a chain, and Nᵢ is the number of chains of that molecular weight.

As used herein, the weight average molecular weight (M_{w}) is defined as:

M_{w}=(ΣNᵢMᵢ²)/ΣNᵢ,

Compared to Mₙ, M_{w} takes into account the molecular weight of a chain in determining contributions to the molecular weight average. The more massive the chain, the more the chain contributes to M.

As used herein, the average molecular weight (Mₓ) can be defined by the equation:

M_{z}=(ΣNᵢMᵢ³)/ΣNᵢ,

“Polydispersity ratio” or “polydispersity index” is a measure of the distribution of molecular mass in a given polymer sample. PDI of a polymer is calculated: PDI=M_{w}/Mₙ. Polymers or oligomers having the same average molecular weight, but having a different molecular polydispersity possess different solution viscosities. The product with the higher polydispersity has a higher solution viscosity, because high molecular weight fractions make a significantly greater contribution toward viscosity than low molecular weight fractions.

In general, “substituted” refers to an alkyl, cycloalkyl, or aryl group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including single, double or triple bonds, to a heteroatom. A substituted group may be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyl, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 30 carbon atoms, and typically from 1 to 24 carbons or, in some embodiments, from 1 to 18 carbon atoms including 1 to about 12 and 1 to about 8. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. Alkyl groups may be unsubstituted or substituted one or more times with various substituents such as those listed above.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 12 ring members, whereas in other embodiments the number of ring carbon atoms range from 5 to 8, 9, 10, 11, or 12 or 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Cycloalkyl groups may be unsubstituted or substituted one or more times with various substituents such as those listed above.

As used herein, “aryl”, or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be unsubstituted or substituted one or more times with various substituents such as those listed above.

Heterocyclyl groups include aromatic (also referred to as heteroaryl) and non-aromatic ring compounds containing 3 or more ring members, of which one or more is a hetero atom such as, but not limited to, N, O, and S. In some embodiments, the heterocyclyl group contains 1, 2, 3 or 4 heteroatoms. In some embodiments, heterocyclyl groups include mono-, bi- and tricyclic rings having 3 to 16 ring members, whereas other such groups have 3 to 6, 3 to 10, 3 to 12, or 3 to 14 ring members. Heterocyclyl groups encompass aromatic, partially unsaturated and saturated ring systems, such as, for example, imidazolyl, imidazolinyl and imidazolidinyl groups. The phrase “heterocyclyl group” includes fused ring species including those comprising fused aromatic and non-aromatic groups. The phrase also includes bridged polycyclic ring systems containing a heteroatom. However, the phrase does not include heterocyclyl groups that have other groups, such as alkyl, oxo or halo groups, bonded to one of the ring members. Rather, these are referred to as “substituted heterocyclyl groups”. Heterocyclyl groups include, but are not limited to, aziridinyl, azetidinyl, pyrrolidinyl, imidazolidinyl, pyrazolidinyl, thiazolidinyl, tetrahydrothiophenyl, tetrahydrofuranyl, dioxolyl, furanyl, thiophenyl, pyrrolyl, pyrrolinyl, imidazolyl, imidazolinyl, pyrazolyl, pyrazolinyl, triazolyl, tetrazolyl, oxazolyl, isoxazolyl, thiazolyl, thiazolinyl, isothiazolyl, thiadiazolyl, oxadiazolyl, piperidyl, piperazinyl, morpholinyl, thiomorpholinyl, tetrahydropyranyl, tetrahydrothiopyranyl, oxathiane, dioxyl, dithianyl, pyranyl, pyridyl, pyrimidinyl, pyridazinyl, pyrazinyl, triazinyl, dihydropyridyl, dihydrodithiinyl, dihydrodithionyl, homopiperazinyl, quinuclidyl, indolyl, indolinyl, isoindolyl,azaindolyl (pyrrolopyridyl), indazolyl, indolizinyl, benzotriazolyl, benzimidazolyl, benzofuranyl, benzothiophenyl, benzthiazolyl, benzoxadiazolyl, benzoxazinyl, benzodithiinyl, benzoxathiinyl, benzothiazinyl, benzoxazolyl, benzothiazolyl, benzothiadiazolyl, benzo[1,3]dioxolyl, pyrazolopyridyl, imidazopyridyl (azabenzimidazolyl), triazolopyridyl, isoxazolopyridyl, purinyl, xanthinyl, adeninyl, guaninyl, quinolinyl, isoquinolinyl, quinolizinyl, quinoxalinyl, quinazolinyl, cinnolinyl, phthalazinyl, naphthyridinyl, pteridinyl, thianaphthyl, dihydrobenzothiazinyl, dihydrobenzofuranyl, dihydroindolyl, dihydrobenzodioxinyl, tetrahydroindolyl, tetrahydroindazolyl, tetrahydrobenzimidazolyl, tetrahydrobenzotriazolyl, tetrahydropyrrolopyridyl, tetrahydropyrazolopyridyl, tetrahydroimidazopyridyl, tetrahydrotriazolopyridyl, tetrahydroquinolinyl, 1,2-diazepanyl, 1,3-diazepanyl, and 1,4-diazepanyl groups. In some embodiments, heterocyclyl groups include pyrrolidine, piperidine, piperazine, imidazole, and morpholine. Heterocyclyl groups may be unsubstituted or substituted one or more times with various substituents such as those listed above.

Groups described herein having two or more points of attachment (i.e., divalent, trivalent, or polyvalent) within the compound of the present technology are designated by use of the suffix, “ene.” For example, divalent alkyl groups are alkylene groups, divalent aryl groups are arylene groups, divalent heteroaryl groups are divalent heteroarylene groups, and so forth. Substituted groups having a single point of attachment to the compound of the present technology are not referred to using the “ene” designation. Thus, e.g., chloro ethyl is not referred to herein as chloroethylene.

In one aspect the present technology provides a process for producing an oligomeric resin adduct, the process including: charging into a reactor a mixture including a vinylic monomer that includes a styrenic monomer, a (meth)acrylic monomer, or a mixture thereof; a polymerization initiator; and optionally a reaction solvent; maintaining the reactor at a temperature sufficient to produce an oligomeric resin from the vinylic monomer, wherein the oligomeric resin contains at least one terminal olefinic unsaturation; and reacting the oligomeric resin with a compound of Formula I (NH₂R¹⁰), Formula II (SHR²⁰), or a mixture thereof; wherein: R¹⁰ is C₁-C₂₄ alkyl chain, C₅-C₁₂ cycloalkyl, C₇-C₁₅ aralkyl (e.g., phenylalkyl), or C₇-C₁₅ aryl (e.g., phenyl); or R¹⁰ is polyethylenimine polymer chain or a polymer chain (straight or branched) substituted by one or more —NH₂ or —NHR¹⁴; R²⁰ is C-C₂₄ alkyl, C₅-C₁₂ cycloalkyl, C₇-C₁₅ aryl (e.g., phenyl), or C₇-C₁₅ aralkyl (e.g., phenylalkyl); or R²⁰ is a polymer chain (straight or branched) substituted by one or more —SH, OH, OR¹⁴, OC(O)R¹¹, or —NHR¹⁴; wherein R¹¹ is C₁-C₁₈ alkyl, C₅-C₁₂ cycloalkyl, C₆-C₁₄ aryl, or C₇-C₁₅ aralkyl; R¹⁴ is C₁-C₂₄ alkyl. The present technology also provides an oligomeric resin adduct of the process provided herein.

In some embodiments, the reactor may be charged continuously with the mixture. In this embodiment, the vinylic monomer, the polymerization initiator, and optionally the reaction solvent are maintained at a sufficient amount to produce the oligomeric resin. In some embodiments the reactor may be a continuous stirred tank reactor. In some embodiments the reactor may be a tubular reactor.

In some embodiments, the oligomeric resin may be isolated prior to reacting the oligomeric resin with a compound of Formula I, Formula II, or a mixture thereof. In some embodiments, the oligomeric resin adduct may be isolated. In some embodiments, the oligomeric resin may be isolated prior to reacting the oligomeric resin with a compound of Formula I, Formula II, or a mixture thereof and the oligomeric resin adduct may be isolated.

In some embodiments, the mixture may include about 20 wt % to about 95 wt % of the vinylic monomer (including 75 wt % to 95 wt %); about 0.10 wt % to about 5 wt % of the polymerization initiator (including 0.1 wt % to 3 wt %); and/or about 0 wt % to about 80 wt % of the reaction solvent (including 5 wt % to 15 wt %).

In some embodiments, the reactor may be maintained at a temperature of from about 160° C. to about 350° C. to produce the oligomeric resin from the vinylic monomer. In some embodiments, the reactor may be maintained at a temperature of from about 170° C. to about 290° C. (including about 205° C. to about 290° C. or about 220° C. to about 290° C.) to produce the oligomeric resin from the vinylic monomer.

In some embodiments, the mixture may be maintained in the reactor for a time sufficient to produce the oligomeric resin from the vinylic monomer. In some embodiments, a residence time of the reaction mixture is from about 5 minutes to about 60 minutes (including about 7 minutes to about 30 minutes and about 10 minutes to about 15 minutes).

The oligmeric resin and the compound of Formula I, Formula II, or a mixture thereof are reacted for a time and termperature sufficient to produce the oligomeric resin adduct. In some embodiments, the oligmeric resin and the compound of Formula I, Formula II, or a mixture thereof are reacted for a time of about 2 hours to about 168 hours including about 2 hours to about 60 hours or about 2.5 hours to about 8 hours. In some embodiments, the oligmeric resin and the compound of Formula I, Formula II, or a mixture thereof are reacted at a temperature of about 20° C. to about 100° C. including about 50° C. to about 90° C. or about 55° C. to about 80° C.

In some embodiments, the reaction does not include a catalyst. In other embodiments, the reaction may include a catalyst. Non limiting catalyst examples include metal salts (e.g., cuprous chloride, iron chloride, and samarium iodide); solid supported catalysts (e.g., silica gel, clay, Amberlyst-15 acidic resins, and sulfated zirconia); and ionic liquids (e.g., 1-butyl-3-methyl imidazolium tetrafluroborate, 1-butyl-3-methyl imidazolium hexafluorophosphate, and other bases with a pKa of 8-14). In some embodiments, the catalyst may be 1,8- diazabicyclo[5.4.0]undec-7-ene (“DBU”), di-n-butylamine (“DBA”), and/or n-octylamine.

In some embodiments, the compounds of Formula I and/or Formula II may have a molecular weight of about about 50 to about 5000 g/mol (preferably about 300 to about 3000 g/mol including about 500-2500 g/mol, about 500-2200 g/mol, and about 1000-2200 g/mol). In some embodiments, the compound of Formula I, Formula II, or a mixture thereof have a molecular weight at least about 1.5 times the molecular weight of the oligomeric resin. In some embodiments, the compound of Formula I, Formula II, or a mixture thereof have a molecular weight at least about twice the molecular weight of the oligomeric resin.

In another aspect the present technology provides an oligomeric resin adduct including an oligomeric resin comprising polymerized vinylic monomer that includes a styrenic monomer, a (meth)acrylic monomer, or a mixture thereof; wherein at least one terminal olefin unsaturation of the oligomeric resin has been reacted with a compound of Formula I, Formula II, or a mixture thereof;

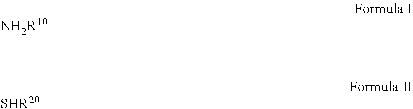

wherein: R¹⁰ is C₁-C₂₄ alkyl chain, C₅-C₁₂ cycloalkyl, C₇-C₁₅ aralkyl (e.g., phenylalkyl), or C₇-C₁₅ aryl (e.g., phenyl); or R¹⁰ is polyethylenimine polymer chain or a polymer chain (straight or branched) substituted by one or more —NH₂ or —NHR¹⁴; R²⁰ is C₁-C₂₄ alkyl, C₅-C₁₂ cycloalkyl, C₇-C₁₅ aryl (e.g., phenyl), or C₇-C₁₅ aralkyl (e.g., phenylalkyl); or R²⁰ is a polymer chain (straight or branched) substituted by one or more —SH, OH, OR¹⁴, OC(O)R¹¹, or —NHR¹⁴; wherein R¹¹ is C₁-C₁₈ alkyl, C₅-C₁₂ cycloalkyl, C₆-C₁₄ aryl, or C₇-C₁₅ aralkyl; R¹⁴ is C₁-C₂₄ alkyl.

In some embodiments, the oligomeric resin may include about 20 wt % to about 95 wt % of the polymerized vinylic monomer (including 75 wt % to 95 wt %).

In some embodiments, the oligomeric resin may be isolated prior to reacting the oligomeric resin with a compound of Formula I, Formula II, or a mixture thereof. In some embodiments, the oligomeric resin adduct may be isolated. In some embodiments, the oligomeric resin may be isolated prior to reacting the oligomeric resin with a compound of Formula I, Formula II, or a mixture thereof and the oligomeric resin adduct may be isolated.

In some embodiments, R¹⁰ is C₁-C₂₄ alkyl chain, C₅-C₁₂ cycloalkyl, C₇-C₁₅ aralkyl, or C₇-C₁₅ aryl; wherein the aralkyl and aryl are optionally substituted on the aryl ring by 1, 2, or 3 C₁-C₄ alkyl; the C₁-C₂₄ alkyl may be optionally substituted by one or more —OH, —OC(O)R¹¹, —OR¹⁴, —Si(OCH₃)₃, —NH₂, —NHCOR¹¹, —NHR¹⁴, —N(R¹⁷)(R¹⁸), or —N(R¹⁴)₂; or the C₁-C₂₄ alkyl may be optionally interrupted by one or more —O—, —NH—, —N(R¹⁴), —NH(CO)—, —NH(CO)O—, —O(CO)— groups or mixtures thereof and optionally substituted by one or more —OH, —OR¹⁵, or —NH₂ groups or mixtures thereof or R¹⁰ is polyethylenimine polymer chain having an Mw about 200 g/mol to about 1000 g/mol or a polymer chain substituted by one or more —NH₂ or —NHR¹⁴ and optionally interrupted by one or more —O—, —OC(O)— or —N(H)— with a molecular weight of about 200 g/mol to about 2000 g/mol; R¹¹ is C₁-C₁₈ alkyl, C₅-C₁₂ cycloalkyl, C₆-C₁₄ aryl or C₇-C₁₅ aralkyl, R¹⁴ and R¹⁵ are independently C₁-C₂₄ alkyl optionally interrupted by one or more —O—, —NH— or —NR¹⁶— groups or mixtures thereof and optionally substituted by one or more —NH—, —OR¹⁹ or —NH₂ groups or mixtures thereof R¹⁶ is C₁-C₂₄ alkyl optionally interrupted by one or more —O—, —NH—, or —NR¹⁹— groups or mixtures thereof and optionally substituted by one or more —OH, —OR¹⁹ or —NH₂ groups or mixtures thereof R¹⁷ and R¹⁸ are independently hydrogen, C₁-C₁₈ alkyl, C₃-C₁₈ alkyl optionally interrupted by —O—, —S—, or —NR¹⁵—, C₅-C₁₂ cycloalkyl, C₆-C₁₄ aryl, or C₁-C₃ hydroxylalkyl; or R¹⁷ and R¹⁸ together with the N atom are a pyrrolidine, piperidine, piperazine, imidazole, or morpholine ring; R¹⁹ is C₁-C₂₄ alkyl; R²⁰ is C₁-C₂₄ alkyl, C₅-C₁₂ cycloalkyl, C₇-C₁₅ aryl, or C₇-C₁₅ aralkyl,wherein the aralkyl and aryl are optionally substituted on the aryl ring by 1, 2, or 3 C₁-C₄ alkyl; the C₁-C₂₄ alkyl is optionally substituted by one or more —OH, —OC(O)R¹¹, —OR¹⁴, —SH; or the C₁-C₂₄ alkyl is optionally interrupted by one or more —O—, —S—, or mixtures thereof and optionally substituted by one or more —OH or —OR¹⁵ groups or mixtures thereof; or R²⁰ is a polymer chain substituted by one or more —SH, —OH, —OR¹⁴, —OC(O)R¹¹, or —NHR¹⁴ and optionally interrupted by one or more —O—, —S—, or —O(CO)— groups with a molecular weight of about 200 g/mol to about 4500 g/mol. In some embodiments, the C₁-C₂₄ alkyl may be interrupted by one or more —O. In some embodiments, the C₁-C₂₄ alkyl may be interrupted by one or more —NH—and/or one or more —N(R¹⁴). In some embodiments, the C₁-C₂₄ alkyl may be interrupted by one or more —NH(CO)—, one or more —NH(CO)O—, and/or one or more —O(CO)—groups.

In some embodiments, R¹⁰ is C₁-C₁₈ alkyl chain; wherein the C₁-C₁₈ alkyl is optionally substituted by one or more —OH, —OC(O)R¹¹, —OR¹⁴, —Si(OCH₃)₃, —NH₂, —NHCOR¹¹, —NHR¹⁴, —N(R¹⁷)(R¹⁸), or —N(R¹⁴)₂; or the C₁-C₁₈ alkyl is optionally interrupted by one or more —O—, —NH—, or —N(R¹⁴)— groups or mixtures thereof and optionally substituted by one or more —OH, —OR¹⁵, or —NH₂ groups or mixtures thereof or R¹⁰ is polyethylenimine polymer chain having an Mw about 200 g/mol to about 1000 g/mol or a polymer chain substituted by one or more —NH₂ or —NHR¹⁴ and optionally interrupted by one or more —O—, —OC(O)— or —N(H)— with a molecular weight of about 200 g/mol to about 2000 g/mol; R¹¹ is C₁-C₁₂ alkyl; R¹⁴ and R¹⁵ are independently C₁-C₁₈ alkyl optionally interrupted by one or more —O—, —NH— or —NR¹⁶— groups or mixtures thereof and optionally substituted by one or more —OH, —OR¹⁹ or —NH₂ groups or mixtures thereof; R¹⁶ is C₁-C₁₈ alkyl optionally interrupted by one or more —O—, —NH— or —NR¹⁹— groups or mixtures thereof and optionally substituted by one or more —OH, —OR¹⁹ or —NH₂ groups or mixtures thereof; R¹⁷ and R¹⁸ are independently hydrogen, C₁-C₁₂ alkyl, C₃-C₁₈ alkyl optionally interrupted by —O—, —S—or —NR¹⁵—, or C₁-C₃ hydroxylalkyl; or R¹⁷ and R¹⁸ together with the N atom are a pyrrolidine, piperidine, piperazine, imidazole, or morpholine ring; R¹⁹ is C₁-C₁₈ alkyl; R²⁰ is C₁-C₁₈ alkyl, wherein the C₁-C₁₈ alkyl is optionally substituted by one or more —OH, —OC(O)R¹¹, —OR¹⁴, —SH; or the C₁-C₁₈ alkyl is optionally interrupted by one or more —O—, —S—, or mixtures thereof and optionally substituted by one or more —OH or —OR¹⁵ groups or mixtures thereof; or R²⁰ is a polymer chain substituted by one or more —SH, OH, OR¹⁴, OC(O)R¹¹, or —NHR¹⁴ and optionally interrupted by one or more —O—, —S—, or O(CO)—groups with a molecular weight of about 200 g/mol to about 4500 g/mol. In some embodiments, the C₁-C₁₈ alkyl may be interrupted by one or more —O—. In some embodiments, the C₁-C₁₈ alkyl may be interrupted by one or more —NH—and/or one or more —N(R¹⁴).

In some embodiments, R¹⁰ is C₁-C₁₈ alkyl wherein the C₁-C₁₈ alkyl is substituted by one or more —OH, —OR¹⁴, —Si(OCH₃)₃, —NH₂, —NHR¹⁴, —N(R¹⁷)(R¹⁸), or —N(R¹⁴)₂; or the C₁-C₁₈ alkyl is interrupted by one or more —O—, —NH—, or —N(R¹⁴)— groups or mixtures thereof; or R¹⁰ is polyethylenimine polymer chain having an Mw about 200 g/mol to about 1000 g/mol or a polymer chain substituted by one or more —NH₂ or —NHR¹⁴ and interrupted by one or more —O—, —OC(O)— or —N(H)— with a molecular weight of about 200 g/mol to about 2000 g/mol; R¹¹ is C₁-C₁₂ alkyl; R¹⁴ and R¹⁵ are independently C₁-C₁₈ alkyl optionally interrupted by one or more —O—, —NH— or —NR¹⁶— groups or mixtures thereof and optionally substituted by one or more —OH, —OR¹⁹ or —NH₂ groups or mixtures thereof; R¹⁶ is C₁-C₁₈ alkyl optionally interrupted by one or more —O—, —NH—or —NR¹⁹— groups or mixtures thereof and optionally substituted by one or more —OH, —OR¹⁹ or —NH₂ groups or mixtures thereof; R¹⁷ and R¹⁸ are independently hydrogen, C₁-C₁₂ alkyl, C₃-C₁₈ alkyl optionally interrupted by —O—, —S—or —NR¹⁵—, or C₁-C₃ hydroxylalkyl; or R¹⁷ and le together with the N atom are a pyrrolidine, piperidine, piperazine, imidazole, or morpholine ring; R¹⁹ is C₁-C₁₈ alkyl; R²⁰ is C₁-C₁₈ alkyl, wherein the C₁-C₁₈ alkyl is optionally substituted by one or more —OH, —OC(O)R¹¹ , —Si(OCH₃)₃, —OR¹⁴, —SH; or the C₁-C₁₈ alkyl is optionally interrupted by one or more —O—, —S—, or mixtures thereof and optionally substituted by one or more —OH or —OR¹⁵ groups or mixtures thereof; or R²⁰ is a polymer chain substituted by one or more —SH, OH, OR¹⁴, OC(O)R¹¹, or —NHR¹⁴ and optionally interrupted by one or more —O—, —S—, or O(CO)— groups with a molecular weight of about 200 g/mol to about 4500 g/mol. In some embodiments, the C₁-C₁₈ alkyl may be interrupted by one or more —O—.

In some embodiments, Formula II may be a compound of Formula (IIa), (IIb) or (IIIc):

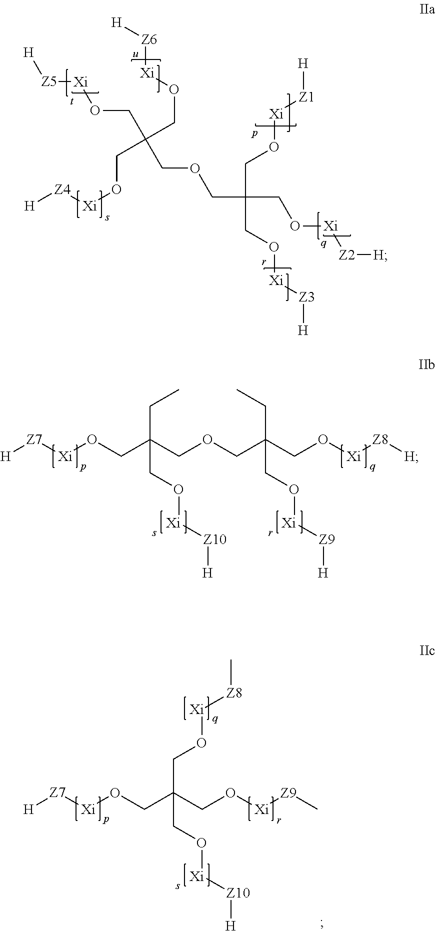

wherein Z1, Z2, Z3, Z4, Z5, Z6, Z7, Z8, Z9, and Z10 are each independently a bond (e.g., single bond) or —C(O)—R³—S— wherein the sulfur atom is attached to the terminal group (i.e., sulfur atom is attached to the terminal —H or —CH₃) and R³ is a C₁-C₂₄ alkylene; p, q, r, s, t, u are each independently 0, 1, 2, 3, 4, or 5; Xi at each occurrence is independently a bond (e.g., single bond), -alkylene-O—, -aralkylene-O—, -alkarylene-O—, or -alkylene-aralkylene-O—; with the proviso that at least one of the Z1 to Z6 is a group of the formula —C(O)—R³—S—, and at least one of the Z7 to Z10 is a group of the formula —C(O)—R³—S—. In some embodiments, Xi at each occurrence is independently selected from the group consisting of single bond, —CH₂—CH₂—O—, —CH₂—CH(CH₃)—O—, —CH(CH₃)—CH₂—O—, —CH₂—C(CH₃)₂—O—, —C(CH₃)₂—CH2—O—, —CH₂—CHPh—O— and CHPh—CH₂—O—(Ph is phenyl). In some embodiments, Xi at each occurrence is a single bond and p, q, r, s, t, u are each zero. In some embodiments, at least two, at least three, at least four, or at least five of the Z1 to Z6 is a group of the formula —C(O)—R³—S—. In some embodiments, at least two, or at least three of the Z7 to Z10 is a group of the formula —C(O)—R³—S—. In some embodiments, Z1 to Z6 are a group of the formula —C(O)—R³—S—. In some embodiments, Z7 to Z10 are a group of the formula —C(O)—R³—S—.

In some embodiments, the compound of Formula II is selected from the group consisting of pentaerythrityl tetra(3-mercaptopropionate) (PETMP), pentaerythrityl tetramercaptoacetate (PETMA), dipentaerythrityl tetra(3-mercaptopropionate), dipentaerythrityl tetramercaptoacetate, dipentaerythrityl penta(3-mercaptopropionate), dipentaerythrityl pentamercaptoacetate, dipentaerythrityl hexa(3-mercaptopropionate), dipentaerythrityl hexamercaptoacetate, ditrimethylolpropane tetra(3-mercaptopropionate), ditrimethylolpropane tetramercaptoacetate, and the ethoxylated and/or propoxylated products thereof.

In some embodiments, Formula II may be a compound of Formula (IId), (IIe), (IIf), or (IIg):

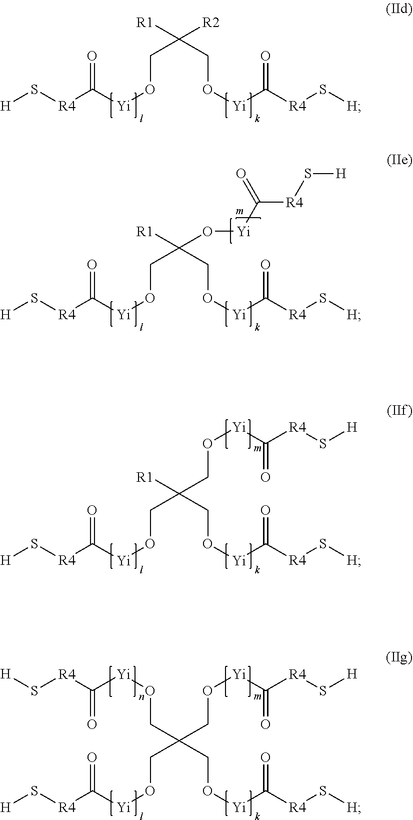

wherein R1 and R2 are each independently hydrogen or a C₁-C₄ alkyl (e.g., methyl, ethyl, propyl, isopropyl, butyl, isobutyl, sec-butyl, or t-butyl); R4 is methylene or ethylene; k, l, m, and n are each independently 0, 1, 2, 3, 4, or 5; Yi at each occurrence is independently a bond (e.g., single bond), -alkylene-O—, -aralkylene-O—, -alkarylene-O—, or -alkylene-aralkylene-O—. In some embodiments, Yi at each occurrence is independently selected from the group consisting of single bonde, —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHPh—O— and CHPh—CH₂—O— (Ph is phenyl). In some embodiments, Yi at each occurrence is a single bond and k, l, m, and n are each zero.

In some embodiments, the compound of Formula II is selected from the group consisting of pentaerythrityl tetra(3-mercaptopropionate) (PETMP), ethylene glycol di(3-mercaptopropionate) (GDMP), trimethylolpropane tri(3-mercaptopropionate) (TMPMP), trimethylolpropane trimercaptoacetate (TMPMA), pentaerythrityl tetramercaptoacetate (PETMA), 3-mercaptopropionic esters of poly-1,2-propylene glycol of weight average molar weight from about 300 to about 5000 g/mol (preferably about 700 to about 3000 g/mol including about 500-2500 g/mol, about 500-2200 g/mol, and about 1000-2200 g/mol) and 3-mercaptopropionic esters of ethoxylated trimethylolpropane of weight average molecular weight from about 300 to about 5000 g/mol (preferably about 700 to about 3000 g/mol including about 500-2500 g/mol, about 500-2200 g/mol, and about 1000-2200 g/mol).

The oligomeric resin may have a weight average molecular weight of about 500 g/mol to about 5000 g/mol. In some embodiments, the oligomeric resin may have a weight average molecular weight of about 500 g/mol to about 5000 g/mol including about 1000 g/mol to about 3000 g/mol, about 800 g/mol to about 5000 g/mol, about 900 g/mol to about 4500 g/mol, or about 1800 g/mol to about 4500 g/mol. The oligomeric resin adduct may have a weight average molecular weight of about 550 g/mol to about 10,000 g/mol. In some embodiments, the oligomeric resin adduct may have a weight average molecular weight of about 2000 g/mol to about 6000 g/mol. In some embodiments, the oligomeric resin adduct may have a weight average molecular weight of about 700 g/mol to about 8000 g/mol, about 800 g/mol to about 7000 g/mol, or about 900 g/mol to about 7000 g/mol.

The vinylic monomer may include a (meth)acrylic monomer. The vinylic monomer may include a styrenic monomer. The vinylic monomer may include a (meth)acrylic monomer and a styrenic monomer. In some embodiments, the oligomeric resin and/or oligomeric resin adduct may include a styrenic oligomer, a (meth)acrylic oligomer, a styrenic (meth)acrylic oligomer, or a mixture or co-polymer of any two or more thereof.

In some embodiments, the vinylic monomer may include from 0 wt % to about 20 wt % of the styrenic monomer and from about 80 wt % to about 100 wt % (meth)acrylic monomer. In some embodiments, the vinylic monomer may include from 0 wt % to about 10 wt % of the styrenic monomer (including 0 to about 5 wt % and 0 to about 1 wt %) and from about 90 wt % to about 100 wt % (meth)acrylic monomer (including about 95 wt % to about 100 wt % and about 99 wt % to about 100 wt %). In some embodiments, the (meth)acrylic monomer may include 0 to about 75 wt % methacrylic acid or ester thereof and about 25 wt % to about 100 wt % acrylic acid or ester thereof In some embodiments, the (meth)acrylic monomer may include about 5 wt % to about 75 wt % methacrylic acid or ester thereof (including about 25 wt % to about 75 w t% and about 45 wt % to about 75 wt %) and about 25 wt % to about 75 wt % acrylic acid or ester thereof (including about 40 wt % to about 75 wt % and about 45 wt % to about 75 wt %).

As used herein, “(meth)acrylic monomers” refer to acrylic or methacrylic acid, esters of acrylic or methacrylic acid, and salts, amides, and other suitable derivatives of acrylic or methacrylic acid, and mixtures thereof Examples of suitable acrylic monomers include, without limitation, the following methacrylate esters: methyl methacrylate, ethyl methacrylate, n-propyl methacrylate, n-butyl methacrylate (BMA), isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate (GMA), benzyl methacrylate, allyl methacrylate, 2-n-butoxyethyl methacrylate, 2-chloroethyl methacrylate, sec-butyl-methacrylate, tent-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate and tetrahydropyranyl methacrylate. Example of suitable acrylate esters include, without limitation, methyl acrylate, ethyl acrylate, n-propyl acrylate, isopropyl acrylate, n-butyl acrylate (BA), n-decyl acrylate, isobutyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluoroethyl acrylate, glycidyl acrylate, benzyl acrylate, allyl acrylate, 2-n-butoxyethyl acrylate, 2-chloroethyl acrylate, sec-butyl-acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropyl acrylate, methallyl acrylate, 3-methoxybutyl acrylate, 2-methoxybutyl acrylate, 2-nitro-2-methylpropyl acrylate, n-octylacrylate, 2-ethylhexyl acrylate, 2-phenoxyethyl acrylate, 2-phenylethyl acrylate, phenyl acrylate, propargyl acrylate, tetrahydrofurfuryl acrylate and tetrahydropyranyl acrylate. Examples of other suitable acrylic monomers include, without limitation, methacrylic acid derivatives such as: methacrylic acid and its salts, methacrylonitrile, methacrylamide, N-methylmethacrylamide, N-ethylmethacrylamide, N,N-diethylmethacrylamide, N,N-dimethylmethacrylamide, N-phenylmethacrylamide and methacrolein. Examples of acrylic acid derivatives include, without limitation, acrylic acid and its salts, acrylonitrile, acrylamide, methyl .alpha.-chloroacrylate, methyl 2-cyanoacrylate, N-ethylacrylamide, N,N-diethylacrylamide and acrolein.

Examples of certain other suitable acrylic or methacrylic acid derivatives include, without limitation, those containing cross-linkable functional groups, such as hydroxy, carboxyl, amino, isocyanate, glycidyl, epoxy, allyl, and the like. The hydroxyalkyl acrylates and methacrylates may contain an alkylene group having from 2 to 6 carbon atoms to which the hydroxy group is attached. Examples of hydroxy functional monomers include, without limitation, hydroxyalkyl acrylates and methacrylates such as 2-hydroxyethyl acrylate (HEA), 3-chloro-2-hydroxypropyl acrylate, 2-hydroxy-butyl acrylate, 6-hydroxyhexyl acrylate, 2-hydroxymethyl methacrylate (HMMA), 2-hydroxypropyl methacrylate (HPMA), 6-hydroxyhexyl methacrylate, and 5,6-dihydroxyhexyl methacrylate.

In some embodiments, the (meth)acrylic monomer may include ethyl acrylate, methyl (meth)acrylate, butyl (meth)acrylate, 2-ethylhexyl (meth)acrylate, hydroxyethyl (meth)acrylate, glycidyl (meth)acrylate, acrylic acid, (meth)acrylic acid, hydroxy propyl (meth)acrylate, hydroxy butyl(meth)acrylate, or a combination of two or more thereof.

In some embodiments, the styrenic monomer may include alpha-methyl styrene (AMS), styrene, vinyl toluene, tertiary butyl styrene, o-chlorostyrene, and the like. In some embodiments, the styrenic monomer may include styrene and/or alpha-methylstyrene. In some embodiments, the styrenic monomer includes styrene and the (meth)acrylic monomer includes glycidyl (meth)acrylate.

In some embodiments, the vinylic monomer may include thermosetting polymers, e.g., terpolymers such as styrene/2-ethylhexyl acrylate/hydroxyethyl methacrylate, styrene/methyl methacrylate/hydroxyethyl methacrylate and styrene/butyl acrylate/hydroxyethyl methacrylate.

In some embodiments, the oligomeric resin may be a “cross-linkable” resin and have functional groups which are cross-linked by heating with a cross-linking agent. The oligomeric resins contain sufficient functional group containing monomers, such as monomers containing cross-linkable functional groups, to allow cross-linking of the polymers. For example, a cross-linkable styrenic (meth)acrylic oligomer may contain from 0% to about 20% by weight of a styrenic monomer, from about 10% to about 50% by weight of an alkyl ester of acrylic or methacrylic acid and from about 20% to about 50% by weight of a hydroxyalkyl acrylate or alkyl methacrylate. The styrenic monomer may be styrene and/or .alpha.-methyl styrene. The alkyl ester of acrylic or methacrylic acid has alkyl groups having from one to eight carbon atoms and includes, for example and without limitation, the methyl, ethyl, propyl, butyl, isobutyl, isoamyl, 2-ethylhexyl and octyl, acrylates and methacrylates.

Examples of curing or cross-linking agents which may be utilized for cross-linking the polymeric products include, without limitation, polyepoxides, polyisocyanates, urea-aldehyde, benzoguanamine aldehyde, melamine-aldehyde condensation products and the like. Examples of melamine-formaldehyde condensation products that act as crosslinking agent include, without limitation, polymethoxymethyl melamines such as hexamethoxymethylmelamine. When melamine-formaldehyde or urea-formaldehyde crosslinking agents are utilized, an acid catalyst, such as toluene sulfonic acid, may be employed to increase the crosslinking rate. Typically, these cross-linking agents are products of reactions of melamine or urea, with formaldehyde and various alcohols containing up to and including 4 carbon atoms. Cross-linking agents also include those sold under the trademark “Cymel.” Without limitation, Cymel 301, Cymel 303 and Cymel 1156, which are alkylated melamine-formaldehyde resins, are useful cross-linking agents.

In some embodiments, the polymerization initiator may include an azo compound, a peroxide, or a mixture of any two or more thereof. For example, the polymerization initiator may include 2,2′-azodi-(2,4-dimethylvaleronitrile); 2,2′-azobisisobutyronitrile (AIBN); 2,2′-azobis(2-methylbutyronitrile); 1,1′-azobis (cyclohexane-1-carbonitrile); tertiary butylperbenzoate; tert-amyl peroxy 2-ethylhexyl carbonate; 1,1-bis(tert-amylperoxy)cyclohexane, tert-amylperoxy-2-ethylhexanoate, tert-amylperoxyacetate, tert-butylperoxyacetate, tert-butylperoxybenzoate, 2,5-di-(tert-butylperoxy)-2,5-dimethylhexane, di-tert-amyl peroxide (DTAP); di-tert-butylperoxide (DTBP); lauryl peroxide; dilauryl peroxide, succinic acid peroxide; benzoyl peroxide; or a combination of two or more thereof.

In some embodiments, the reaction solvent may include acetone, aromatic 100, aromatic 150, aromatic-200, ethyl-3-ethoxypropionate, methyl amyl ketone, methylethylketone, methyl-iso-butylketone, N-methylpyrrolidone, (propylene glycol monomethyl ether acetate, xylene, toluene, ethyl benzene, carbitol, cyclohexanol, dipropylene glycol (mono)methyl ether, n-butanol, n-hexanol, hexyl carbitol, iso-octanol, iso-propanol, methyl cyclohexane methanol, decyl alcohol, lauryl alcohol, myristal alcohol, cetyl alcohol, stearyl alcohol, behenyl alcohol, isoparaffins, or a combination of two or more thereof.

In another aspect, the present technology provides a composition the includes the oligomeric resin adduct as described herein. The present technology also provides a composition the includes the oligomeric resin adduct produced by the process as described herein. In some embodiments, the compositions may be a printing ink, surface coating, chalk, sealant or overprint varnish.

The composition may include additional components commonly included in printing ink, surface coating, chalk, sealant or overprint varnish. For example, printing ink compositions may include: pigments and/or dyes (organic and inorganic); dispersants (surfactants and polymers); resins or polymers to improve binding, rheology and mechanical properties; humectants to retard premature drying; defoamers and antifoaming agents; wetting agents enhance contact with the substrate; pH modifiers (usually amine derivatives); biocides and bacteriostats to inhibit the growth of bacteria and fungi. Other ingredients and details may be found in Ink chemistry, Chemistry World 1, Mar. 2003 (herein incorporated by reference). Coatings compositions on substrates have long been used for appearance and for protection against weathering as well as, for example, safety insulation, and vapor barrier. Coating compositions are generally considered to be composed of four basic components: pigment(s), binder (or nonvolatile vehicle), volatile vehicle (or carrier), and additives. Pigments, which may be either organic or inorganic compositions, supply the desired color of a coating composition and are selected for proper opacity and gloss. The binder is a substance which, when exposed to the atmosphere or heat, forms a dry coating or film, and provides the medium for the pigment. Binders are typically resins (often synthetic polymeric materials), drying oils, or mixtures of such materials. The volatile vehicle may make up to 50% of the volume of the coating composition, but is vaporized into the atmosphere when the wet coating film is dried or cured. The volatile vehicle in solvent-based (also called solvent-borne) coating composition is typically an organic solvent, such an aromatic hydrocarbon (e.g., xylene or toluene) or an aliphatic hydrocarbon (e.g., mineral spirits or naphtha), while the volatile vehicle in water-based (also called water-borne) coating composition is, of course, water. In the largest group of water-based coating compositions, the binder is emulsified into the water medium, i.e., the binder is dispersed as tiny droplets in the water, the binder being the internal phase and the water being the external phase. For clear coats, no pigments are present. Additives are agents used to facilitate acceptable film formation. Additives for a typical water-based paint include coalescents, thickeners, defoamers, preservatives, pH controllers, and anti-freezes. Coalescents are typically added to plasticize the binder temporarily during film formation so that the emulsion particles coalesce. Thickeners are often added to promote suspension of the pigment during storage, proper rheology for application, and flow without sagging. Preservatives are often added for protection during storage against bacterial attack, while the other additives are added to minimize foaming, adjust pH, prevent surface defects, and provide freeze/thaw stability. Other ingredients and details may be found in U.S. Pat. No. 5,700,522; US 2017/0137289; U.S. Pat. Nos. 9,718,737; 9,353,285; WO 2002/040579 (each of which is incorporated herein by reference). Overprint varnish compositions may include: a binder resin or a mixture of binder resins, a solvent and additives such as fillers, surfactants, varnishes, wax, adhesion promoters and the like. Other ingredients and details may be found in US 2002/0121631; U.S. Pat. No. 4,040,995; EP 2,620,480A1; EP 0,919,600A1 (each of which is incorporated herein by reference).

In some embodiments, the coating resin includes but is not limited to a thermoset acrylic melamine resin, an acrylic urethane resin, an epoxy carboxy resin, a silane modified acrylic melamine, an acrylic resin with carbamate pendant groups crosslinked with melamine, or an acrylic polyol resin crosslinked with melamine containing carbamate groups.

Suitable coating resins include but are not limited to polyurethane resins, acrylate resins, and polyester resins which are customarily employed in basecoat and/or clear coat materials in the field of the automotive industry. In some embodiments, the coating resin is a polyurethane resin, in combination where appropriate with one or more polyacrylate resins and/or with one or more polyester resins.

Polyurethane resins can be prepared by reacting at least one hydroxyl containing oligomeric resin adduct of the instant invention, a mixture of at least one hydroxyl containing oligomeric resin adduct of the instant invention and a polyol selected from the group consisting of acrylic polyols, polyesterpolyols and polyetherpolyols or mixtures there of. The polyol may have a number-average molecular weight of 100 to 5000, and at least one polyisocyanate and also if desired, at least one compound containing at least one isocyanate-reactive functional group and at least one (potentially) anionic group in the molecule, if desired, at least one further compound containing at least one isocyanate-reactive functional group, and if desired, at least one compound with a number-average molecular weight of 60 to 600 daltons, containing hydroxyl and/or amino groups in the molecule, and, in the case of polyurethane resins used for aqueous coating materials, neutralizing the resultant reaction product. Polyurethane resins of this kind are described for example in EP-B-228 003 and EP-B-574 417.

In some embodiments, polyurethane resins of this kind can be obtained, for example, by using as the isocyanate component isocyanates that are commonly used in the field of the paint industry. Some illustrative examples of the isocyanate include, but is not limited to, hexamethylene diisocyanate, octamethylene diisocyanate, decamethylene diisocyanate, dodecamethylene diisocyanate, tetradecamethylene diisocyanate trimethylhexane diisocyanate, tetramethylhexane diisocyanate, isophorone diisocyanate, 2-isocyanatopropylcyclohexyl isocyanate, dicyclohexylmethane 2,4′-diisocyanate, dicyclohexylmethane 4,4′-diisocyanate, 1,4- or 1,3-bis(isocyanatomethyl)cyclohexane, 1,4- or 1,3- or 1,2-diisocyanatocyclohexane, 2,4- or 2,6-diisocyanato-l-methylcyclo-hexane, diisocyanates derived from dimer fatty acids, as sold under the trade designation DDI 1410 by Henkel, 1,8-diisocyanato-4-isocyanato-methyloctane, 1,7-diisocyanato-4-isocyanatomethylheptane or 1-isocyanato-2-(3-isocyanatopropyl)cyclohexane, tetramethylxylylene diisocyanates (TMXDI), or mixtures of these polyisocyanates. In some embodiments, the isocyanate is tetramethylxylylene diisocyanates (TMXDI) and/or isophorone diisocyanate. In some embodiments, the isocyanate is isophorone diisocyanate.

Suitable coating resins in base coat (pigmented) or clear coat coating materials, together with or instead of the polyurethane resins, also include acrylated polyurethane resins. Acrylated polyurethane resins can be prepared by polymerizing ethylenically unsaturated monomers in the presence of a polyurethane resin. In this context it is possible to use polyurethane resins without double bonds and/or polyurethane resins with double bonds.

In some embodiments, the acrylated polyurethane resin has pendant and/or terminal double bonds. In some embodiments, the acrylated polyurethane resin has pendant and/or terminal ethenylarylene groups.

Acrylated polyurethane resins with pendant and/or terminal double bonds can be prepared by reacting a polyurethane prepolymer containing at least one free isocyanate group with a compound which contains at least one ethylenically unsaturated double bond and one group that is reactive toward NCO groups, in particular a hydroxyl group or an amino group.

Acrylated polyurethane resins with pendant and/or terminal double bonds can also be obtained by reacting a polyurethane prepolymer containing at least one group that is reactive toward NCO groups, in particular at least one hydroxyl group or one amino group, with a compound which contains at least one ethylenically unsaturated double bond and one free isocyanate group.

In some embodiments, the coating resin is a graft copolymer which can be prepared by polymerizing olefinically unsaturated monomers in the presence of the acrylated polyurethane resins having pendant and/or terminal double bonds. In some embodiments, the graft copolymer has a hydrophobic core which includes at least one copolymerized olefinically unsaturated monomer and a hydrophilic shell which includes at least one hydrophilic acrylated polyurethane. In other embodiments, the graft copolymer contains a hydrophobic core which includes at least one hydrophobic acrylated polyurethane and a hydrophilic shell which includes at least one copolymerized olefinically unsaturated monomer.

Non-limiting examples of acrylated polyurethane resins and graft copolymers prepared therefrom them are described WO 01/25307 and in EP-B-787 159.

In some embodiments, the polyurethane resin described herein can be used where appropriate in combination with one or more polyacrylate resins and/or with one or more polyester resins. Non-limiting examples of polyester resins include saturated or unsaturated polyester resins. In some embodiments, the polyester resin is saturated. In some embodiments, the polyester resin has a number-average molecular weight of 400 to 5000. Some non-limiting examples of polyester resins are described for example in EP-B-787 159.

In some embodiments, the amount of coating resin in the coating composition provided herein is generally 10% to 99% by weight based on the solids content of the coating resin. In some embodiments, the amount of coating resin present in the coating composition is 30% to 90% by weight based on the solids content of the coating resin.

In some embodiments, the coating resin contains a cross-linking agent. In some embodiments, the amount of crosslinking agent in the coating resin is 0 to 55% by weight based on the solids content of the coating resin. In some embodiments, the amount of crosslinking agent present in the coating resin is 5% to 40% by weight based on the solids content of the coating resin.

In some embodiments, the crosslinking agents are free isocyanates or blocked isocyanates and/or amino resins. Non-limiting suitable isocyanates include the isocyanates utilized to prepare polyurethane resins as described above and isocyanates that are commonly used in the paints industry. In some embodiments, the isocyanate is TACT, dimethylpyrazole-blocked trimeric hexamethylene diisocyanate, and/or trimeric hexamethylene diisocyanate.

Non-limiting examples of blocking agents include all commonly employed blocking agents, such as the corresponding alcohols, amines, ketones, pyrazoles, etc. In some embodiments, the blocking agent has a deblocking temperature less than 130° C.

Non-limiting examples of amino resins include amino resins that are commonly used in the paints industry, the properties of the pigmented coating materials being controllable via the reactivity of the amino resins. In some embodiments, the amino resin is a butanol-etherified amino resin. In some embodiments, the amino resin is Cymel® 203.

In another aspect, an article made from any of the above oligomeric resin adduct is provided. In one embodiment, the article is used in direct contact with food. For example, the article may be used in food contact applications where the article may be exposed to temperatures of up to 250° C. In another aspect, a polymeric composition is provided including the oligomeric resin adduct as a flow modifier, compatibilizer, plasticticizer, reactive plasticizer, stress releasing agent, viscosity modifier, fuel additive, or dispersant. In another aspect, a plastic article is provided including oligomeric resin adduct as a sheet, a film, a foam, a bottle, or an extrusion coating.

The present invention, thus generally described, will be understood more readily by reference to the following examples, which are provided by way of illustration and are not intended to be limiting of the present invention.

### EXAMPLES

### General Procedures

¹H NMR spectra were acquired with a 300 MHz Varian Instrument and was used to determine terminal double content of (oligomeric resin). Sample preparation included dissolving resin in deuterated chloroform or DMSO. Terminal double bond (“TBD”) content was determined by integrating vinyl hydrogen at 5.2 and 6.2 ppm peaks relative to hydrogen peaks in the polymer backbone.

GPC spectra were acquired with a Waters 2695 instrument and was used to determine molecular weight ofpolymers using THF as the mobile phase at 40° C. and a RI detector. All samples were analyzed for Mₙ, M_{w}, and PDI using elution times calibrated against polystyrene molecular weight standards.

Infrared spectra were acquired via an iS50 ATR FT-IR instrument. The area of IR peaks corresponding to vinyl groups at 1630 cm-1 was used to determine the residuals vinyl peaks in the polymer. Conversion of the vinyl peaks was determined by comparing the area of the 1630 cm⁻¹ peak at time, t, relative of the area at time=0.

Quantification of residual monomers was performed by GC/FID using an external standard method. GC analysis was performed on a ZB-5MSi, a nonpolar capillary column with the following characteristics: 30 m, 0.25 mm internal diameter, 0.25 μm. The oven temperature for the column was ramped with 5° C./min from 35° C. to 175° C. Amine values were determined using a potentiometric method using 0.1 N perchloric acid as the titrant. Samples were prepared by dissolving the reaction product in a mixture of acetic acid and acetonitrile and stirring until homogeneous.

Example 1. Synthesis of Oligomeric Resins Containing Terminal Double Bonds. The oligomeric resins containing terminal double bonds were produced using a stainless steel reactor (continuous stirred tank reactor, “CSTR”) connected in series to a flash evaporator and a condenser unit. The monomer, solvent, and initiator mixture was fed continuously with a volumetric rate of 8.4 cc/min (to achieve a 12-min residence time in the CSTR reactor) at various temperatures. Volatiles were distilled by flashing off in a tank at 200-300° C. under 130-0.1 mbar vacuum. The desired oligomeric resins were obtained as shown below.

| | 1-1 @ | 1-2 @ | 1-3 @ | 1-4 @ | 1-5 @ | |
|---|---|---|---|---|---|---|
| Feed | 288° C. | 288° C. | 220° C. | 220° C. | 220° C. | |
| nBA | 88 g | 44 g | 22 g | 22 g | 22 | g |
| nBMA | 0 | 44 g | 66 g | 66 g | 66 | g |
| Solvent | 11 g | 11 g | 11 g | 11 g | 11.9 | g |
| Free | 1 g | 1 g | 1 g | 1 g | 0.1 | g |
| Radical | | | | | | |
| Initiator | | | | | | |

| | | | | | |
|---|---|---|---|---|---|
| Residence | 12 | 12 | 12 | 12 | 12 |
| Time (min) | | | | | |
| TDB/chain | 0.67 | 0.95 | 0.97 | 0.97 | 0.99 |
| Mn | 1431 | 938 | 1224 | 1285 | 2026 |
| Mw | 4185 | 1884 | 2384 | 2185 | 4441 |
| PDI | 2.92 | 2.01 | 1.95 | 1.5 | 2.19 |

nBA = n-butyl acrylate, nBMA = n-butyl methacrylate, Solvent = xylene, Free Radical Initiator = di-tert-butyl peroxide (DTBP), TDB = terminal double bond.

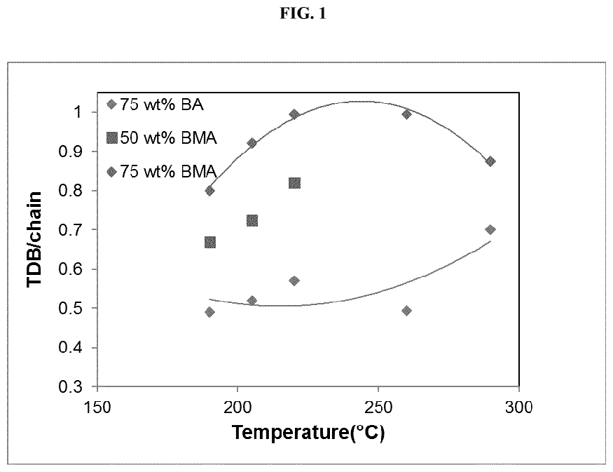

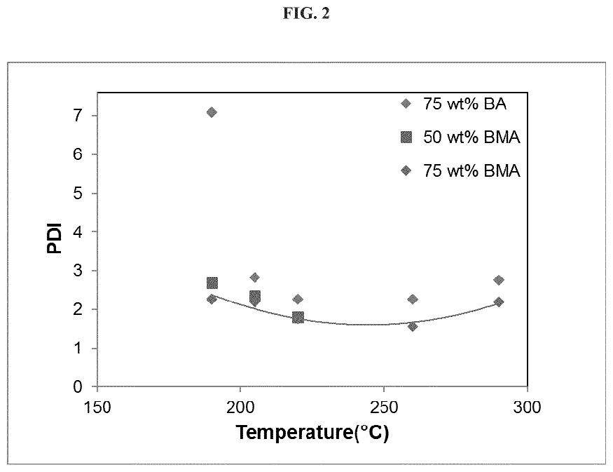

Example 2. Synthesis of Oligomeric Resins Containing Terminal Double Bonds. Following the continuous process of Example 1 and varying the temperature and monomer concentration, the following oligomeric co-block resins were produced. Solvent was xylene (11 wt % of the feed) and initiator was DTBP (1 wt % of the feed). The effect of temperature and acrylate/methacrylate ratio on acrylic acid copolymers TBD concentration is shown in FIG. 1. The effect of temperature and acrylate/methacrylate ratio on acrylic acid copolymers polydispersity is shown in FIG. 2.

| | | | | Temp | | |
|---|---|---|---|---|---|---|
| Example | AA | BA | BMA | (C.) | TDB | PPI |
| 2-1 | 25 | 75 | 0 | 190 | 0.49 | 7.08 |
| 2-2 | 50 | 0 | 50 | 190 | 0.67 | 2.68 |
| 2-3 | 25 | 0 | 75 | 190 | 0.80 | 2.26 |
| 2-4 | 25 | 75 | 0 | 205 | 0.52 | 2.82 |
| 2-5 | 50 | 0 | 50 | 205 | 0.72 | 2.35 |
| 2-6 | 25 | 0 | 75 | 205 | 0.92 | 2.19 |
| 2-7 | 25 | 75 | 0 | 220 | 0.57 | 2.27 |
| 2-8 | 50 | 0 | 50 | 220 | 0.82 | 1.81 |
| 2-9 | 25 | 0 | 75 | 220 | 0.99 | 1.76 |
| 2-10 | 25 | 75 | 0 | 260 | 0.49 | 2.26 |
| 2-11 | 25 | 0 | 75 | 260 | 0.99 | 1.56 |
| 2-12 | 25 | 75 | 0 | 290 | 0.70 | 2.75 |
| 2-13 | 25 | 0 | 75 | 290 | 0.85 | 2.20 |

TBD = terminal double bonds per chain,
AA = acrylic acid,
BA = n-butyl acrylate,
BMA = n-butyl methacrylate

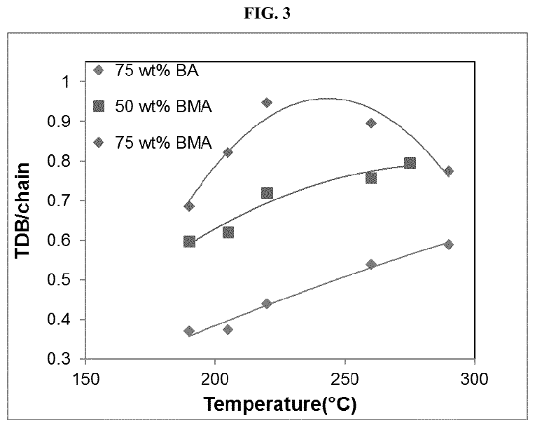

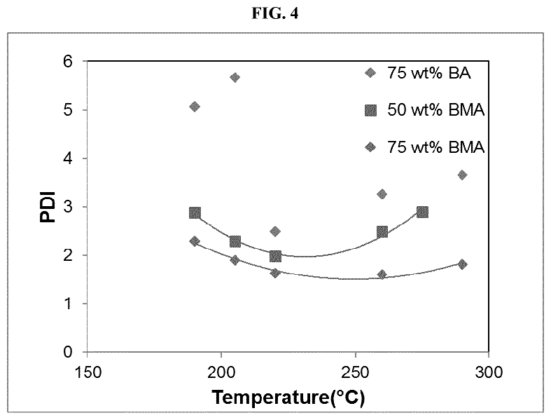

Example 3. Synthesis of Oligomeric Resins Containing Terminal Double Bonds. Following the continuous process of Example 1 and varying the temperature and monomer concentration, the following oligomeric co-block resins were produced. Solvent was xylene (11 wt % of the feed) and initiator was DTBP (% of the feed). The effect of temperature and acrylate/methacrylate ratio on hydroxyethyl acrylate copolymers TBD concentration is shown in FIG. 3. The effect of temperature and acrylate/methacrylate ratio on hydroxyethyl acrylate copolymers polydispersity is shown in FIG. 4.

| | | | | Temp | | |
|---|---|---|---|---|---|---|
| Example | HEA | BA | BMA | (C.) | TDB | PDI |
| 3-1 | 25 | 75 | 0 | 190 | 0.37 | 5.07 |
| 3-2 | 50 | 0 | 50 | 190 | 0.60 | 2.88 |
| 3-3 | 25 | 0 | 75 | 190 | 0.69 | 2.30 |
| 3-4 | 25 | 75 | 0 | 205 | 0.37 | 5.67 |
| 3-5 | 50 | 0 | 50 | 205 | 0.62 | 2.30 |
| 3-6 | 25 | 0 | 75 | 205 | 0.83 | 1.90 |
| 3-7 | 25 | 75 | 0 | 220 | 0.44 | 2.49 |
| 3-8 | 50 | 0 | 50 | 220 | 0.72 | 1.99 |
| 3-9 | 25 | 0 | 75 | 220 | 0.95 | 1.63 |
| 3-10 | 25 | 75 | 0 | 260 | 0.54 | 3.26 |
| 3-11 | 50 | 0 | 50 | 260 | 0.76 | 2.49 |
| 3-12 | 25 | 0 | 75 | 260 | 0.90 | 1.61 |
| 3-13 | 25 | 75 | 0 | 290 | 0.59 | 3.66 |
| 3-14 | 50 | 0 | 50 | 290 | 0.80 | 2.90 |
| 3-15 | 25 | 0 | 75 | 290 | 0.77 | 1.82 |

HEA = hydroxyethyl acrylate

Example 4. Synthesis of Oligomeric Resins Containing Terminal Double Bonds. Following the continuous process of Example 1 and varying the initiator concentration, the following oligomeric AA/BMA co-block resins were produced. Reaction temperature was 220° C., solvent was xylene (varied from 11 wt % to 11.9 wt %), used 22 wt % AA and 66 wt % BMA.

| | DTBP | Mₙ | |
|---|---|---|---|
| Example | (wt %) | (g/mol) | TBD/Chain |
| 4-1 | 0.1 | 2079 | 1.02 |
| 4-2 | 0.25 | 1741 | 1.05 |
| 4-3 | 0.50 | 1486 | 0.96 |
| 4-4 | 1.0 | 1309 | 0.88 |

DTBP = di-tertiarybutyl peroxide

Example 5. Reaction of Oligomeric Resin Containing Terminal Double Bonds with Di-thiols. Oligomeric resin (Example 1-2, 15.44 g) was added to a 20 mL scintillation vial followed by the addition of 1,6-hexanedithiol (Sigma Aldrich, 0.54 g) and 1,8-diazabicyclo[5.4.0]undec-7-ene (DBU, Sigma Aldrich, 0.05 g). The solution was mixed at room temperature on a mechanical stirrer for 5 minutes until homogenous. The scintillation vial was capped using a Teflon backed cap then placed in a convection oven at 80° C. for 60 hours. Final products were characterized by ¹H NMR for percent conversion to the desired product.

| | | | | | | % |
|---|---|---|---|---|---|---|
| Experi- | Oligomeric | TBD | Thiol | Dithiol | Catalyst | Conver- |
| ment | Resin (g) | (mol) | (eq) | (g) | (g) | sion |
| 5-1 | 14.94 | 0.0068 | 0.0069 | 0.52 | DBA | 30 |
| | | | | | 0.05 | |
| 5-2 | 15.44 | 0.0070 | 0.0072 | 0.54 | DBU | 90 |
| | | | | | 0.05 | |

DBU = 1,8-diazabicyclo[5.4.0]undec-7-ene,
DBA = di-n-butylamine,
oligomeric resin = Example 1-1

Example 6. Reaction of Oligomeric Resin Containing Terminal Double Bonds with Polypropyleneglycol 3-mercaptopropionate.

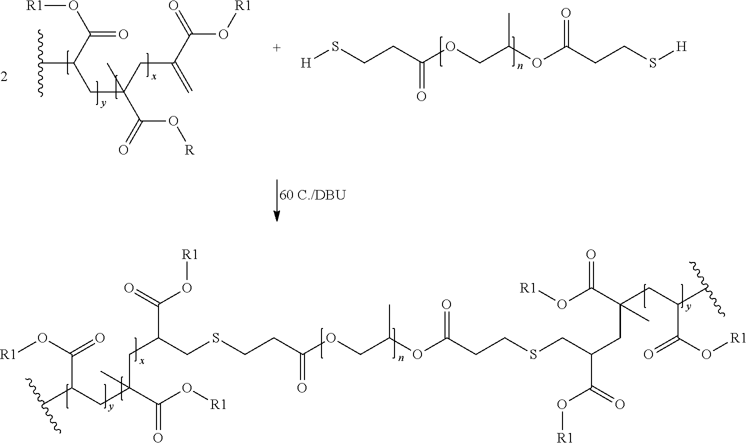

The reaction was carried out in a 4-neck round-bottom 1L flask equipped with a mechanical stiffer, a reflux condenser, a nitrogen intake, and a thermocouple. A heating mantle connected to a temperature controller was used to control the reaction temperature. Oligomeric resin (Example 1-5, 100 g, 0.082 mole TBD) and Thiocure PPGMP 2200 (Bruno Bock, Mn=2176 g/mol, 108.8 g, 0.09 mole of thiol) were charged first to the reactor while stirring between 200 and 250 rpm. Once the desired reaction temperature (60° C.) was reached, the reactor was sparged with nitrogen. The catalyst (DBU, 1.0 weight percent) was charged to the reactor to start the reaction and allowed to continue for 150 minutes. Reaction progress was monitored via ¹H NMR and FTIR for TDB concentration and GPC for molecular weight until complete conversion was obtained. The desired product was obtained as a little yellow clear resinous liquid having a Mₙ=3776 and M_{w}=6996.

Example 7. Reaction of Oligomeric Resin Containing Terminal Double Bonds with Ethoxylated-trimethylolpropan-tri(3-mercaptopropionate).

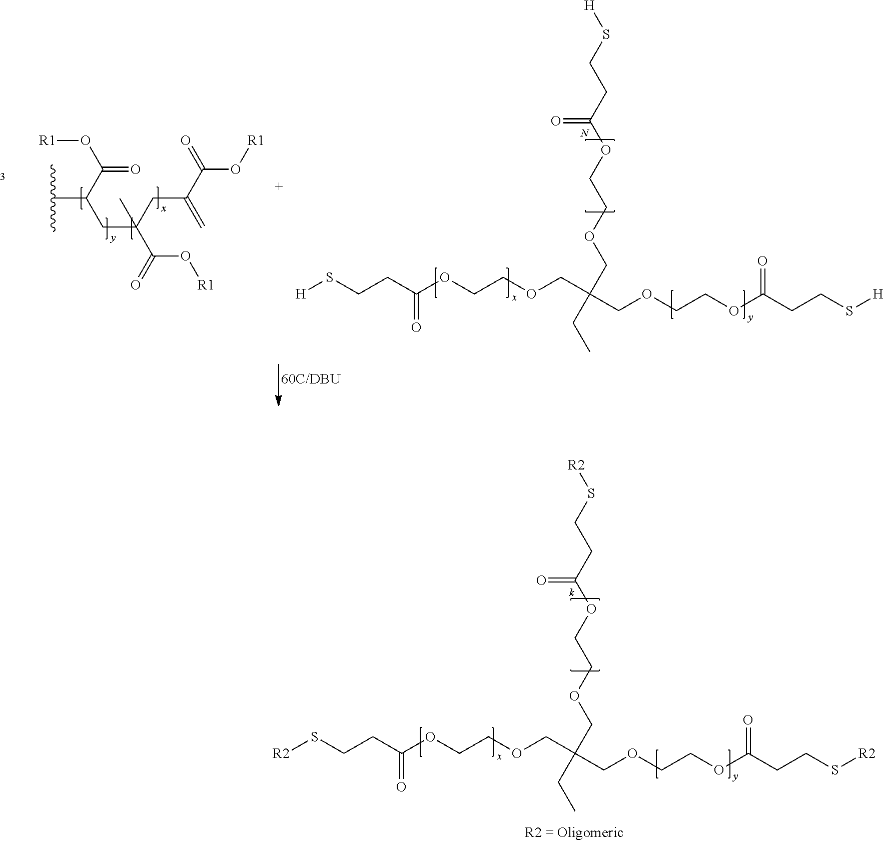

The reaction was carried out in a 4-neck round-bottom 1L flask equipped with a mechanical stirrer, a reflux condenser, a nitrogen intake, and a thermocouple. A heating mantle connected to a temperature controller was used to control the reaction temperature. Oligomeric resin as shown in the table below and Thiocure ETTMP 1300 (Bruno Bock, Mn=about 1300 g/mol) were charged first to the reactor while stirring between 200 and 250 rpm. Once the desired product temperature (60° C.) was reached, the reactor was sparged with nitrogen. The catalyst (DBU, Sigma Aldrich) was charged to the reactor to start the reaction and allowed to continue for 8 hours. Reaction progress was monitored via ¹H NMR and FTIR for TDB concentration. The reaction was judged complete by the disappearance of vinyl-type protons in the ¹H NMR and desired product was obtained as a light yellow clear liquid with a 100 percent conversion.

| | Resin | TDB | thiol | thiol | thiol/ | DBU | DBU |
|---|---|---|---|---|---|---|---|
| Experiment | (g) | (mol) | (g) | (eq) | TDB | (g) | wt % |
| 7-1* | 28.30 | 0.0285 | 13.00 | 0.0300 | 0.99 | 0.45 | 1.09 |
| 7-2* | 102.7 | 0.11 | 52.2 | 0.1210 | 1.10 | 0.155 | 0.10 |
| 7-3** | 100 | 0.082 | 38.9 | 0.090 | 1.10 | 1.26 | 0.9 |
| 7-4** | 76 | 0.062 | 40.4 | 0.093 | 1.50 | 0.486 | 0.4 |

*Resin is from Example 1-2,
**Resin is from Example 1-3

Example 8. Reaction of Oligomeric Resin Containing Terminal Double Bonds with Ethoxylated-trimethylolpropan-tri(3-mercaptopropionate) using Octylamine as a Catalyst. The reaction was carried out in a 4-neck round-bottom 1L flask equipped with a mechanical stiffer, a reflux condenser, a nitrogen intake, and a thermocouple. A heating mantle connected to a temperature controller was used to control the reaction temperature. Oligomeric resin as shown below and Thiocure ETTMP 1300 (Bruno Bock, Mn=about 1300 g/mol) were charged first to the reactor while stirring between 200 and 250 rpm. Once the desired product temperature (60° C.) was reached, the reactor was sparged with nitrogen. The catalyst (n-octylamine, Sigma Aldrich) was charged to the reactor to start the reaction and allowed to continue for 5 hours. Reaction progress was monitored via ¹H NMR and FTIR for TDB concentration. The reaction was judged complete by the disappearance of vinyl-type protons in the ¹H NMR. Lower octylamine catalyst of 0.4 wt % achieved a conversion of 22% while at the higher catalyst loadings of 0.8 and 1.7 wt % achieved a conversion of 70%. The desired product was obtained as light yellow clear liquid.

| | Resin | TDB | thiol | thiol | thio/ | amine | amine |
|---|---|---|---|---|---|---|---|
| Example | (g) | (mol) | (g) | (eq) | TDB | (g) | wt % |
| 8-1* | 100 | 0.079 | 37.1 | 0.086 | 1.10 | 0.55 | 0.4 |
| 8-2* | 100 | 0.079 | 37.1 | 0.086 | 1.10 | 1.32 | 0.8 |
| 8-3** | 100 | 0.082 | 38.9 | 0.090 | 1.10 | 2.47 | 1.7 |

*Resin is from Example 1-4,
**Resin is from Example 1-3,
amine = n-octylamine

Example 9. Reaction of Oligomeric Resin Containing Terminal Double Bonds with Thioglycerol using Octylamine as a Catalyst. The reaction was carried out in a 4-neck round-bottom 1L flask equipped with a mechanical stiffer, a reflux condenser, a nitrogen intake, and a thermocouple. A heating mantle connected to a temperature controller was used to control the reaction temperature. Oligomeric resin (Example 1-1, 100 g, 0.046 mole of terminal double bonds) and thioglycerol (Sigma Aldrich, 4.98 g, 0.046 mole) were charged first to the reactor while stirring between 200 and 250 rpm. Once the desired product temperature (65 C.) was reached, the reactor was sparged with nitrogen. The catalyst (n-octylamine, Sigma Aldrich, 0.8 wt %) was charged to the reactor to start the reaction and allowed to continue for 9 hours. Reaction progress was monitored via ¹H NMR and FTIR for TDB concentration. The reaction was judged complete by the disappearance of vinyl-type protons in the ¹H NMR. The desired product was obtained as light yellow clear resinous liquid at an 83% conversion.

Example 10. Reaction of Acrylic Oligomers Containing Terminal Double Bonds with Primary Amines using no Catalyst. Following the synthetic conditions of Example 6, an oligomeric resin was reacted with the various primary amines described in the table below using 15 wt % n-butanol (Sigma Aldrich) as a solvent. Solvent and excess amine were removed after the reaction by wiped film evaporation.

| Experi- | | TDB:Amine | Temp | Time | | Product |
|---|---|---|---|---|---|---|
| ment | Amine | Ratio | (C.) | (hrs) | Yield | Appearance |
| 10-1* | TEPA | 1:5 | 22 | 72 | 97 | Light yellow |
| | | | | | | resinous liquid |
| 10-2** | TEPA | 1:5 | 22 | 168 | 93 | Light yellow |
| | | | | | | resinous liquid |
| 10-3* | DDA | 1:5 | 22 | 120 | 95 | Light yellow |
| | | | | | | resinous liquid |
| 10-4* | API | 1:5 | 22 | 120 | 94.5 | Light yellow |
| | | | | | | resinous liquid |
| 10-5* | NBA | 1:5 | 22 | 120 | 98.6 | Light yellow |
| | | | | | | resinous liquid |
| 10-6* | TEPA | 1:5 | 60 | 49 | 64 | Light yellow |
| | | | | | | resinous liquid |
| 10-7* | TEPA | 1:5 | 90 | 16 | 75 | Light yellow |
| | | | | | | resinous liquid |
| 10-8* | PEI | 1:2 | 22 | 168 | 86 | Light yellow |
| | | | | | | resinous liquid |
| 10-9** | TEPA | 1:2 | 22 | 168 | 84 | Light yellow |
| | | | | | | resinous liquid |
| 10-10* | TEPA | 1:1.2 | 22 | 168 | 60 | Light yellow |
| | | | | | | resinous liquid |
| 10-11* | TEPA | 1:1.2 | 60 | 49 | 63 | Light yellow |
| | | | | | | resinous liquid |
| 10-12* | TEPA | 1:1.2 | 90 | 16 | 74 | Light yellow |
| | | | | | | resinous liquid |
| 10-13* | TEPA | 1:0.95 | 22 | 168 | 48 | Light yellow |
| | | | | | | resinous liquid |
| 10-14* | API | 1:1.2 | 22 | 168 | 24 | Light yellow |
| | | | | | | resinous liquid |

*Oligomeric resin = BA/BMA molar ratio =1:3, Mₙ = 950 g/mol, PDI = 1.46;
**Oligomeric resin = BA/BMA molar ratio =1:3, Mₙ = 1850 g/mol;, TEPA = tetraethylenepentamine; DDA = N,N-diethylethylenediamine; API = 1-(3-aminopropyl)-imidazole; NBA = n-butylamine, PEI = polyethyleneimine, M_{w} = 600 g/mol

Example 11. Solvent Borne Mill Base Pigment Concentrate Viscosity. To a container, the appropriate amount of oligomeric resin, carbon black FW 200, and 1-methoxy-2-propyl acetate were combined to give final weight of 35 grams of mill base at a pigment concentration of 15 wt % at either 1:1 or 1:2 resin:pigment weight ratio. To this container was added 35 grams of glass spheres (2 mm size) and mixed on a Skandex for four hours. After mixing, the glass spheres were removed by filtration. The resulting mill base viscosities were then measured after one day at 22° C. The results are provided in the table below.

| | | MB Viscosity | MB Viscosity |
|---|---|---|---|
| | | @1 s⁻¹ | @1 s⁻¹ |
| | | (mPas) − 1:2 | (mPas) − 1:1 |
| | | Resin/Pigment | Resin/Pigment |
| Experiment | Resin | Weight Ratio | Weight Ratio |
| 11-1 | Oligomeric resin* | Gelled | Gelled |
| 11-2 | PEI-Based | 157430 | 410 |
| | Dispersant** | | |
| 11-3 | 10-13 | 63415 | 1955 |
| 11-4 | 10-10 | 44764 | 1810 |
| 11-5 | 10-11 | 41424 | 730 |
| 11-6 | 10-12 | 40079 | 679 |
| 11-7 | 10-9 | 36209 | 398 |

*Oligomeric resin = BA/BMA molar ratio =1:3, Mₙ = 950 g/mol, PDI = 1.46 containing terminal double bonds used without derivatization,
**PEI-Based Dispersant is a commercial branched chain resin dispersant based on polyethylenimine having an Mw of 20,000 g/mol;
MB = Mill Base

The instant oligomeric resin adducts provided a lower viscosity and lower viscosity range at 1:2 & 1:1 resin/pigment concentrations, which is highly desired.

Example 12. Solvent Borne Mill Base Pigment Let Down and Film Formation. To a container, 2 grams of the appropriate mill base was added to 8 grams of cellulose acetate butyrate/acrylic melamine clear coat and agitated for five minutes on a paint shaker to ensure uniform mixing. The pigmented coating was applied to black Leneta cards using draw down bars to obtain a coating thickness of about 1.5 mil dry film thickness wherein 1 mil is equal to 0.0254 mm or 25.4 microns. The panels were allowed to air dry for 2 days followed by oven curing at 60° C. for 60 minutes. Film integrity was then inspected to ensure that no seeding had occurred due to pigment agglomeration and uniform films were obtained.

| | | Mill Base | Pigment | |
|---|---|---|---|---|
| | | Resin/Pigment | Seeding or | Film |
| Experiment | Mill Base | Weight Ratio | Agglomeration | Formation |
| 12-1 | 11-2 | 1:1 | None | Good, No |
| | | | | Defects |
| 12-2 | 11-2 | 1:2 | None | Good, No |
| | | | | Defects |
| 12-3 | * | 1:1 | None | Good, No |
| | | | | Defects |
| 12-4 | * | 1:2 | None | Good, No |
| | | | | Defects |
| 12-5 | ** | 1:1 | None | Good, No |
| | | | | Defects |
| 12-6 | ** | 1:2 | None | Good, No |
| | | | | Defects |

* Utilized mill base procedure according to Instant Example 11 and oligomeric resin adduct shown in Instant Example 10-8.
** Utilized mill base procedure according to Instant Example 11 and oligomeric resin adduct shown in Instant Example 10-14.

The instant oligomeric resin adducts were highly effect as pigment dispersants as judged by no pigment seeded or agglomeration during pigment formulation preparation and provided good uniform films when cured, which is highly desired.

Example 13. Waterborne Pigment Concentrate. To a container, the appropriate amount of oligomeric resin adduct, pigment red 57:1, and a commercial polyether siloxane defoamer (1.0 wt %, Foamex 810) were combined. To this container was added an equivalent mass of glass spheres (2 mm size) and mixed on a Skandex for four hours. After mixing, the glass spheres were removed by filtration. The resulting mill base was let down with deionized water yielding a pigment slurry having 40 wt % concentration at a resin/pigment weight ratio of 1:3.

Example 14. Synthesis of Oligomeric Resins Containing Terminal Double Bonds and Hydroxyl Groups. Following the continuous process of Examples 1 and 2, the following hydroxyl group and terminal double bond containing oligomeric resin was produced.

| | Mn | Mw | Measured OH | TBD/ | Tg |
|---|---|---|---|---|---|
| Composition | (g/mol) | (g/mol) | Value | Chain | (C.) |
| BA 38%, MMA, | 1279 | 2426 | 96 | 0.88 | −22 |
| 40%, HEMA 22% | | | | | |

Example 15. Reaction of Oligomeric Resin Containing Terminal Double Bonds with Ethanolamine using no Catalyst. Following the general reaction conditions as outlined in Instant Example 10, the hydroxyl group and terminal double bond containing oligomeric resin from Example 14 was used as a starting material and reacted with 2 molar equivalents of ethanol amine using 15 weight n-butanol as a cosolvent. At a reaction temperature of 60 C. and reaction time of 50 hours, the terminally hydroxylated resin was obtained in a 84% yield after solvent stripping. The desired product was obtained as a light yellow clear resinous liquid having a Mₙ=1294, M_{w}=2709, measured OH value=128, and a Tg=−5.7 C.

Example 16. Reaction of Oligomeric Resin Containing Terminal Double Bonds with Thioglycerol using no Catalyst. Following the general reaction conditions as outlined in Instant Example 10, the hydroxyl group and terminal double bond containing oligomeric resin from Example 14 was used as a starting material and reacted with 1 molar equivalent of thioglycerol using 15 weight n-butanol as a cosolvent. At a reaction temperature of 60 C. and reaction time of 24 hours, the terminally hydroxylated resin was obtained in a 83% yield after solvent stripping. The desired product was obtained as a light yellow clear resinous liquid having a Mₙ=1269, M_{w}=2477, measured OH value=164, and a Tg=−22.5C.

Example 17. Synthesis of Oligomeric Resins Containing Terminal Double Bonds. Following the continuous process of Examples 1 and 2, the following terminal double bond containing oligomeric resins were produced.

| | | Mn | Mw | |
|---|---|---|---|---|
| Example | Composition | (g/mol) | (g/mol) | TBD/Chain |
| 17-1 | BA 39%, MMA, 61% | 1650 | 5312 | 0.90 |
| 17-2 | BA 50%, MMA, 50% | 1662 | 3337 | 0.92 |

Example 18. Reaction of Oligomeric Resin Containing Terminal Double Bonds with 3-Mercaptopropyltrimethoxysilane using no Catalyst. Following the general reaction conditions as outlined in Instant Example 10, the terminal double bond containing oligomeric resin (Example 17-2) was used as a starting material and reacted with 1.1 molar equivalents of 3-mercaptopropyltrimethoxysilane (Dynasylan MTMO, Evonik)) using methanol as a cosolvent. At a reaction temperature of 60 C. and reaction time of 24 hours, the terminally substituted trimethoxy silane oligomeric resin was obtained in a 50% yield after solvent stripping. The desired product was obtained as a light yellow clear resinous liquid having a Mₙ=1933, M_{w}=4725, solids=97.8 weight %, and a Tg=−5.3C.

Example 19. Reaction of Oligomeric Resin Containing Terminal Double Bonds with 3-Aminopropyltrimethoxysilane using no Catalyst. Following the general reaction conditions as outlined in Instant Example 10, the terminal double bond containing oligomeric resin (Example 17-2) was used as a starting material and reacted with 1.2 molar equivalents of 3-aminopropyltrimethoxysilane (Silquest A-1110, Momentive) using methanol as a cosolvent. At a reaction temperature of 60 C. and reaction time of 50 hours, the terminally substituted trimethoxy silane oligomeric resin was obtained in an 80% yield after solvent stripping. The desired product was obtained as a light yellow clear resinous liquid having a Mₙ=1593, M_{w}=3290, solids=96 weight %, and a Tg=−24.9C.

Example 20. 2-Part Solvent-borne Polyurethane Glossy Clear Top Coating Composition. The oligomeric resin adducts were dissolved in methylamyl ketone at 66 weight percent solids with 0.02 phr of di-n-butyltin dilaurate as a catalyst. The crosslinker (Basonat HI 100, aliphatic polyisocyanate, NCO equivalent weight, 191 g/mol, BASF) was added at a 1.05 molar excess relative to polyol hydroxyl number. The instant clear coat compositions were applied over white base coated aluminum substrates at about 40 microns dry film thickness using drawdown bars. The coatings were cured under controlled temperature and humidity conditions.

Chemical resistance testing was done using ASTM D5402-15 and 88 wt % methylethyl ketone (MEK). The values given below represent the average of three trials each. Konig hardness was evaluated according to ASTM D4366-16.

| Example | Resin | MEK Double Rubs |
|---|---|---|
| 20-1 | Example 16 | 360 |
| 20-2 | Example 15 | 130 |
| 20-3 | Comp. Ex. 3-1 | 100 |
| 20-4 | Comp. Ex. 3-2 | 75 |

| | Example | | | |
|---|---|---|---|---|
| | | | 20-3 | 20-4 |
| | 20-1 | 20-2 | Comp. | Comp. |
| Resin | Example 16 | Example 15 | Ex. 3-1 | Ex. 3-2 |
| König hardness | 0 | 0 | 0 | 0 |
| at 0 days | | | | |
| König hardness | 60 | 66 | 50 | 35 |
| at 3 days | | | | |
| König hardness | 110 | 86 | 66 | 48 |
| at 12 days | | | | |
| König hardness | 120 | 92 | 67 | 46 |
| at 17 days | | | | |

The instant oligomeric resin adducts demonstrated improved chemical resistance and Konig hardness compared with polyol resins found in the art.

Comparative Example 1. Reaction of Acrylic Oligomers Containing Terminal Double Bonds with Di-n-butylamine. Following the synthetic conditions of Example 10, an oligomeric resin (BA/BMA molar ratio=1:3, Mn=950) was reacted with the di-n-butylamine using 15 wt % n-butanol (Sigma Aldrich) as a solvent at room temperature for 5 days with agitation. No conversion (0% yield) was achieved. Not wishing to be bound by theory, the inventors believe the secondary nitrogen atoms within the tetraethylene pentamine or a polyethyleneimine do not participate in an aza-Michael reaction.

Comparative Example 2. Reaction of Acrylic Oligomers Containing Terminal Double Bonds with an amine in butyl acetate as the solvent. Following the synthetic conditions of U.S. Pat. No. 7,678,850 Example 2, an oligomeric resin containing terminal double bonds (BA/BMA molar ratio=1:3, Mn=3000) was mixed with the tetraethylenepentamine using 60 wt % n-butylacetate (Sigma Aldrich) as a solvent at room temperature for 18 days with agitation. After three weeks of reaction time, the described disappearance of the vinyl peaks in 1H-NMR could not be observed. No conversion (0% yield) was achieved.

Comparative Example 3. Acrylic Polyol. Following hydroxyl group containing resins (not terminally substituted) were synthesized according to U.S. Pat. No. 4,529,787 Example 1 (Table 1) having the following properties:

| | | Mn | Mw | Measured | Tg |
|---|---|---|---|---|---|
| Number | Composition* | (g/mol) | (g/mol) | OH Value | (C.) |
| Comp. | STY, 2-EHA, | 1275 | 2393 | 157 | −23 |
| Ex. 3-1 | HEMA | | | | |
| Comp. | STY, 2-EHA, | 1265 | 2425 | 111 | −12 |
| Ex. 3-2 | HEMA | | | | |

STY = Styrene,
2-EHA = 2-Ethylhexyl acrylate,
HEMA = hydroxyethyl methylacrylate
*Concentration of hydroxyethyl methylacrylate was changed so that the measured hydroxy value could be obtained.

While certain embodiments have been illustrated and described, it should be understood that changes and modifications may be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations may be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like, include the number recited and refer to ranges which may be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1.-26. (canceled)

27. A process for producing an oligomeric resin adduct comprising:
charging continuously into a reactor a mixture comprising:
about 20 wt % to about 95 wt % of a vinylic monomer comprising a styrenic monomer, a (meth)acrylic monomer, or a mixture thereof;
about 0.10 wt % to about 5 wt % of a polymerization initiator; and
about 0 wt % to about 80 wt % of a reaction solvent;
maintaining the reactor at a temperature of about 160° C. to about 350° C. to produce an oligomeric resin from the vinylic monomer; and
isolating the oligomeric resin, wherein the oligomeric resin contains at least one terminal olefinic unsaturation; and
reacting the oligomeric resin with a compound of Formula I, Formula II, or a mixture thereof; 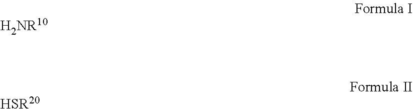
and isolating the oligomeric resin adduct;
wherein:
R¹⁰ is C₁-C₂₄ alkyl chain, C₅-C₁₂ cycloalkyl, C₇-C₁₅ aralkyl, or C₇-C₁₅ aryl;
wherein the aralkyl and aryl are optionally substituted on the aryl ring by 1, 2, or 3 C₁-C₄ alkyl; the C₁-C₂₄ alkyl is optionally substituted by one or more —OH, —OC(O)R¹¹, —OR¹⁴, —Si(OCH₃)_{3,} —NH₂, —NHCOR¹¹, —NHR¹⁴, —N(R¹⁷)(R¹⁸), or N(R¹⁴)₂; or the C₁-C₂₄ alkyl is optionally interrupted by one or more —O—, —NH—, —N(R¹⁴), —NH(CO)—, —NH(CO)O—, —O(CO)— groups or mixtures thereof and optionally substituted by one or more —OH, —OR¹⁵, or —NH₂ groups or mixtures thereof; or
R¹⁰ is polyethylenimine polymer chain having an Mw about 200 g/mol to about 1000 g/mol or a polymer chain substituted by one or more —NH₂ or —NHR¹⁴ and optionally interrupted by one or more —O—, —OC(O)— or —N(H)— with a molecular weight of about 200 g/mol to about 2000 g/mol;
R¹¹ is C₁-C₁₈ alkyl, C₅-C₁₂ cycloalkyl, C₆-C₁₄ aryl or C₇-C₁₅ aralkyl,
R¹⁴ and R¹⁵ are independently C₁-C₂₄ alkyl optionally interrupted by one or more —O—, —NH— or —NR¹⁶— groups or mixtures thereof and optionally substituted by one or more —OH, —OR¹⁹ or —NH2 groups or mixtures thereof;
R16 is C₁-C₂₄ alkyl optionally interrupted by one or more —O—, —NH— or —NR¹⁹— groups or mixtures thereof and optionally substituted by one or more —OH, —OR¹⁹ or —NH₂ groups or mixtures thereof;
R¹⁷ and R¹⁸ are independently hydrogen, C₁-C₁₈ alkyl, C₃-C₁₈ alkyl optionally interrupted by —O—, —S— or —NR¹⁵—, C₅-C₁₂ cycloalkyl, C₆-C₁₄ aryl, or C₁-C₃ hydroxylalkyl; or R¹⁷ and R¹⁸ together with the N atom are a pyrrolidine, piperidine, piperazine, imidazole, or morpholine ring;
R¹⁹ is C₁-C₂₄ alkyl;
R²⁰ is C₁-C₂₄ alkyl, C₅-C₁₂ cycloalkyl, C₇-C₁₅ aryl, or C₇-C₁₅ aralkyl,
wherein the aralkyl and aryl are optionally substituted on the aryl ring by 1, 2, or 3 C₁-C₄ alkyl; the C₁-C₂₄ alkyl is optionally substituted by one or more —OH, —OC(O)R¹¹, —OR¹⁴, —Si(OCH₃)₃, —SH; or the C₁-C₂₄ alkyl is optionally interrupted by one or more —O—, —S—, or mixtures thereof and optionally substituted by one or more —OH or —OR¹⁵ groups or mixtures thereof; or
R²⁰ is a polymer chain substituted by one or more —SH, OH, OR¹⁴, OC(O)R¹¹, or —NHR¹⁴ and optionally interrupted by one or more —O—, —S—, or O(CO)— groups with a molecular weight of about 200 g/mol to about 4500 g/mol.

28. The process of claim 27, wherein the oligomeric resin has a weight average molecular weight of about 500 g/mol to about 5000 g/mol.

29. The process of claim 27, wherein the vinylic monomer comprises a (meth)acrylic monomer.

30. The process of claim 29, wherein the vinylic monomer further comprises a styrenic monomer.

31. The process of claim 27, wherein the oligomeric resin and/or oligomeric resin adduct comprises a styrenic oligomer, a (meth)acrylic oligomer, a styrenic (meth)acrylic oligomer, or a mixture or co-polymer of any two or more thereof.

32. The process of claim 27, wherein the polymerization initiator comprises an azo compound, a peroxide, or a mixture of any two or more thereof.

33. The process of claim 27, wherein the polymerization initiator comprises 2,2′-azodi-(2,4-dimethylvaleronitrile); 2,2′-azobisisobutyronitrile (AIBN); 2,2′-azobis(2-methylbutyronitrile); 1,1′-azobis (cyclohexane-1-carbonitrile); tertiary butylperbenzoate; tert-amyl peroxy 2-ethylhexyl carbonate; 1,1-bis(tert-amylperoxy)cyclohexane, tert-amylperoxy-2-ethylhexanoate, tert-amylperoxyacetate, tert-butylperoxyacetate, tert-butylperoxybenzoate, 2,5-di-(tert-butylperoxy)-2,5-dimethylhexane, di-tert-amyl peroxide (DTAP); di-tert-butylperoxide (DTBP); lauryl peroxide; dilauryl peroxide, succinic acid peroxide; or benzoyl peroxide.

34. The process of claim 27, wherein the reaction solvent comprises acetone, aromatic 100, aromatic 150, aromatic-200, ethyl-3-ethoxypropionate, methyl amyl ketone, methylethylketone, methyl-iso-butylketone, N-methylpyrrolidone, (propylene glycol monomethyl ether acetate, xylene, toluene, ethyl benzene, carbitol, cyclohexanol, dipropylene glycol (mono)methyl ether, n-butanol, n-hexanol, hexyl carbitol, iso-octanol, iso-propanol, methyl cyclohexane methanol, decyl alcohol, lauryl alcohol, myristal alcohol, cetyl alcohol, stearyl alcohol, behenyl alcohol, or isoparaffins.

35. The process of claim 27, wherein the (meth)acrylic monomer comprises ethyl acrylate, methyl (meth)acrylate, butyl (meth)acrylate, 2-ethylhexyl (meth)acrylate, hydroxyethyl (meth)acrylate, glycidyl (meth)acrylate, acrylic acid, (meth)acrylic acid, hydroxy propyl (meth)acrylate, or hydroxy butyl(meth)acrylate.

36. The process of claim 27, wherein the styrenic monomer comprises styrene or alpha-methylstyrene.

37. The process of claim 27, wherein the styrenic monomer comprises styrene and the (meth)acrylic monomer comprises glycidyl (meth)acrylate.

38. The process of claim 27, wherein the vinylic monomer comprises from 0 wt % to about 20 wt % of the styrenic monomer and from about 80 wt % to about 100 wt % (meth)acrylic monomer.

39. The process of claim 27, wherein
R¹⁰ is C₁-C₁₈ alkyl chain;
wherein the C₁-C₁₈ alkyl is optionally substituted by one or more —OH, —OC(O)R¹¹, —OR¹⁴, —Si(OCH₃)₃, —NH₂, —NHCOR¹¹, —NHR¹⁴, —N(R¹⁷)(R¹⁸), or —N(R¹⁴)₂; or the C₁-C₁₈ alkyl is optionally interrupted by one or more —O—, —NH—, or —N(R¹⁴)— groups or mixtures thereof and optionally substituted by one or more —OH, —OR¹⁵, or —NH₂ groups or mixtures thereof; or
R¹⁰ is polyethylenimine polymer chain having an Mw about 200 g/mol to about 1000 g/mol or a polymer chain substituted by one or more —NH₂ or —NHR¹⁴ and optionally interrupted by one or more —O—, —OC(O)— or —N(H)— with a molecular weight of about 200 g/mol to about 2000 g/mol;
R¹¹ is C₁-C₁₂ alkyl;
R¹⁴ and R¹⁵ are independently C₁-C₁₈ alkyl optionally interrupted by one or more —O—, —NH— or —NR¹⁶— groups or mixtures thereof and optionally substituted by one or more —OH, —OR¹⁹ or —NH₂ groups or mixtures thereof;
R¹⁶ is C₁-C₁₈ alkyl optionally interrupted by one or more —O—,—NH— or —NR¹⁹— groups or mixtures thereof and optionally substituted by one or more —OH, —OR¹⁹ or —NH₂ groups or mixtures thereof;
R¹⁷ and R¹⁸ are independently hydrogen, C₁-C₁₂ alkyl, C₃-C₁₈ alkyl optionally interrupted by —O—, —S— or —NR¹⁵—, or C₁-C₃ hydroxylalkyl; or R¹⁷ and R¹⁸ together with the N atom are a pyrrolidine, piperidine, piperazine, imidazole, or morpholine ring;
R¹⁹ is C₁-C₁₈ alkyl;
R²⁰ is C₁-C₁₈ alkyl,
wherein the C₁-C₁₈ alkyl is optionally substituted by one or more —OH, —OC(O)R¹¹, —OR¹⁴, —Si(OCH₃)₃, —SH; or the C₁-C₁₈ alkyl is optionally interrupted by one or more —O—, —S—, or mixtures thereof and optionally substituted by one or more —OH or —OR¹⁵ groups or mixtures thereof; or
R²⁰ is a polymer chain substituted by one or more —SH, OH, OR¹⁴, OC(O)R¹¹, or —NHR¹⁴ and optionally interrupted by one or more —O—, —S—, or O(CO)— groups with a molecular weight of about 200 g/mol to about 4500 g/mol.

40. The process of claim 27, wherein
R10 is C₁-C₁₈ alkyl, wherein the C₁-C₁₈ alkyl is substituted by one or more —OH, —OR¹⁴, —Si(OCH₃)₃, —NH₂, —NHR¹⁴, —N(R¹⁷)(R¹⁸), or —N(R¹⁴)₂; or the C₁-C₁₈ alkyl is interrupted by one or more —O—, —NH—, or —N(R¹⁴)— groups or mixtures thereof; or
R¹⁰ is polyethylenimine polymer chain having an Mw about 200 g/mol to about 1000 g/mol or a polymer chain substituted by one or more —NH₂ or —NHR¹⁴ and interrupted by one or more —O—, —OC(O)— or —N(H)— with a molecular weight of about 200 g/mol to about 2000 g/mol;
Ru¹¹ is C₁-C₁₂ alkyl;
R¹⁴ and R¹⁵ are independently C₁-C₁₈ alkyl optionally interrupted by one or more —O—, —NH— or —NR¹⁶— groups or mixtures thereof and optionally substituted by one or more —OH, —OR¹⁹ or —NH₂ groups or mixtures thereof;
R¹⁶ is C₁-C₁₈ alkyl optionally interrupted by one or more —O—, —NH— or —NR¹⁹— groups or mixtures thereof and optionally substituted by one or more —OH, —OR¹⁹ or —NH₂ groups or mixtures thereof;
R¹⁷ and R¹⁸ are independently hydrogen, C₁-C₁₂ alkyl, C₃-C₁₈ alkyl optionally interrupted by —O—, —S— or —NR¹⁵—, or C₁-C₃ hydroxylalkyl; or R¹⁷ and R¹⁸ together with the N atom are a pyrrolidine, piperidine, piperazine, imidazole, or morpholine ring;
R¹⁹ is C₁-C₁₈ alkyl;
R²⁰ is C₁-C₁₈ alkyl, wherein the C₁-C₁₈ alkyl is optionally substituted by one or more —OH, —OC(O)R¹¹, —OR¹⁴, —Si(OCH₃)₃, —SH; or the C₁-C₁₈ alkyl is optionally interrupted by one or more —O—, —S—, or mixtures thereof and optionally substituted by one or more —OH or —OR¹⁵ groups or mixtures thereof; or
R²⁰ is a polymer chain substituted by one or more —SH, OH, OR¹⁴, OC(O)R¹¹, or —NHR¹⁴ and optionally interrupted by one or more —O—, —S—, or O(CO)— groups with a molecular weight of about 200 g/mol to about 4500 g/mol.

41. The process of claim 27, wherein Formula II is Formula (IIa), (IIb) or (IIc): 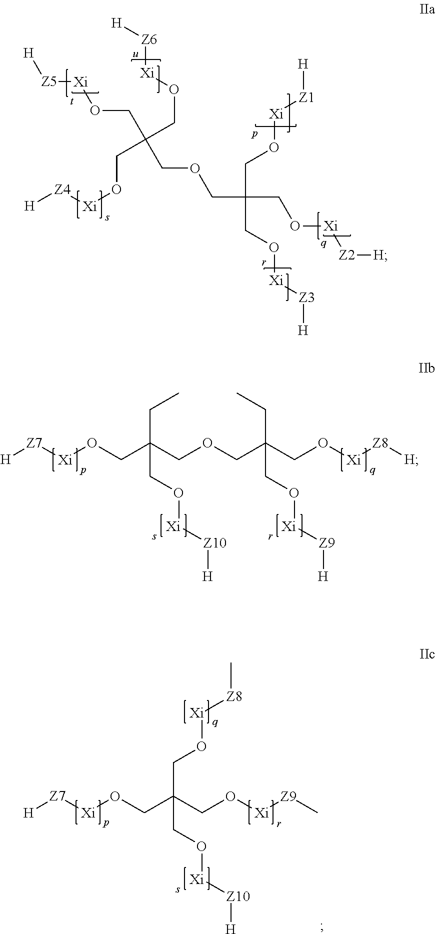
wherein:
Z1, Z2, Z3, Z4, Z5, Z6, Z7, Z8, Z9, and Z10 are each independently a bond or —C(O)—R³—S—, wherein the sulfur atom is attached to the terminal group and R³ is a C₁-C₂₄ alkylene;
p, q, r, s, t, u are each independently 0, 1, 2, 3, 4, or 5;
Xi at each occurrence is independently be selected from the group consisting of a bond, —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHPh—O— and CHPh—CH₂—O—;
with the proviso that at least one of the Z1 to Z6 is a group of the formula —C(O)—R³—S—, and at least one of the Z7 to Z10 is a group of the formula —C(O)—R³—S—.

42. The process of claim 27, wherein Formula II is a compound selected from the group consisting of pentaerythrityl tetra(3-mercaptopropionate) (PETMP), pentaerythrityl tetramercaptoacetate (PETMA), dipentaerythrityl tetra(3-mercaptopropionate), dipentaerythrityl tetramercaptoacetate, dipentaerythrityl penta(3-mercaptopropionate), dipentaerythrityl pentamercaptoacetate, dipentaerythrityl hexa(3-mercaptopropionate), dipentaerythrityl hexamercaptoacetate, ditrimethylolpropane tetra(3-mercaptopropionate), ditrimethylolpropane tetramercaptoacetate, and the ethoxylated and/or propoxylated products thereof.

43. The process of claim 27, wherein Formula II is Formula (IId), (IIe), (IIf), or (IIg): 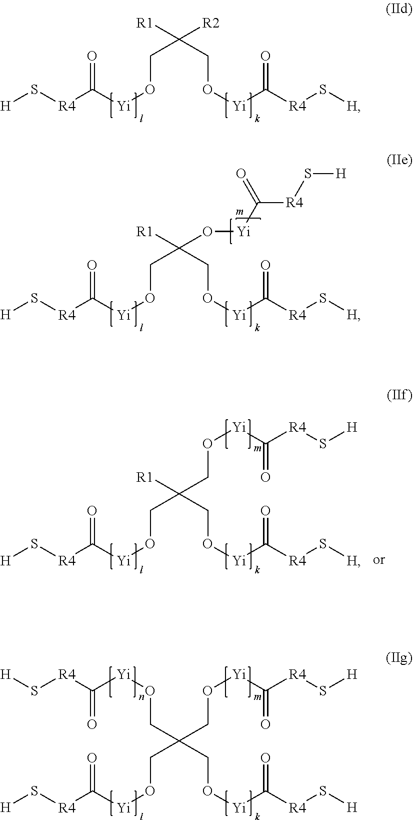
wherein:
R1 and R2 are each independently hydrogen or a C₁-C₄ alkyl;
R4 is methylene or ethylene;
k, l, m, and n are each independently 0, 1, 2, 3, 4, or 5;
Yi at each occurrence is independently be selected from the group consisting of —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHPh—O— and CHPh—CH₂—O—.

44. The process of claim 27, wherein Formula II is a compound selected from the group consisting of pentaerythrityl tetra(3-mercaptopropionate) (PETMP), ethylene glycol di(3-mercaptopropionate) (GDMP), trimethylolpropane tri(3-mercaptopropionate) (TMPMP), trimethylolpropane trimercaptoacetate (TMPMA), pentaerythrityl tetramercaptoacetate (PETMA), 3-mercaptopropionic esters of poly-1,2-propylene glycol of weight average molar weight from about 300 to about 5000 g/mol and 3-mercaptopropionic esters of ethoxylated trimethylolpropane of weight average molecular weight from about 300 to about 5000 g/mol.

45. The process of claim 27, further comprising maintaining the vinylic monomer, the polymerization initiator, and optionally the reaction solvent at a sufficient amount to produce the oligomeric resin, wherein the reactor is a continuous stirred tank reactor.

46. An oligomeric resin adduct comprising:
about 20 wt % to about 95 wt % of an oligomeric resin comprising polymerized vinylic monomer comprising a styrenic monomer, a (meth)acrylic monomer, or a mixture thereof;
wherein at least one terminal olefin unsaturation of the oligomeric resin has been reacted with a compound of Formula I, Formula II, or a mixture thereof; 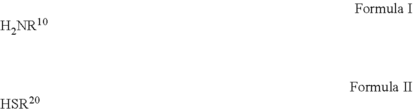
wherein:
R¹⁰ is C₁-C₂₄ alkyl chain, C₅-C₁₂ cycloalkyl, C₇-C₁₅ aralkyl, or C₇-C₁₅ aryl;
wherein the aralkyl and aryl are optionally substituted on the aryl ring by 1, 2, or 3 C₁-C₄ alkyl; the C₁-C₂₄ alkyl is optionally substituted by one or more —OH, —OC(O)R¹¹, —OR¹⁴, —Si(OCH₃)₃, —NH₂, —NHCOR¹¹, —NHR¹⁴, —N(R¹⁷)(R¹⁸) or —N(R¹⁴)₂; or the C₁-C₂₄ alkyl is optionally interrupted by one or more —O—, —NH—, or —N(R¹⁴)— groups or mixtures thereof and optionally substituted by one or more —OH, —OR¹⁵, or —NH₂ groups or mixtures thereof; or
R¹⁰ is polyethylenimine polymer chain having an Mw about 200 g/mol to about 1000 g/mol or a polymer chain substituted by one or more —NH₂ or —NHR¹⁴ and optionally interrupted by one or more —O—, —OC(O)— or —N(H)— with a molecular weight of about 200 g/mol to about 2000 g/mol;
R¹¹ is C₁-C₁₈ alkyl, C₅-C₁₂ cycloalkyl, C₆-C₁₄ aryl or C₇-C₁₅ aralkyl,
R¹⁴ and R¹⁵ are independently C₁-C₂₄ alkyl optionally interrupted by one or more —O—, —NH— or —NR¹⁶— groups or mixtures thereof and optionally substituted by one or more —OH, —OR¹⁹ or —NH₂ groups or mixtures thereof;
R16 is C₁-C₂₄ alkyl optionally interrupted by one or more —O—, —NH— or —NR¹⁹— groups or mixtures thereof and optionally substituted by one or more —OH, —OR¹⁹ or —NH2 groups or mixtures thereof;
R¹⁷ and R¹⁸ are independently hydrogen, C₁-C₁₈ alkyl, C₃-C₁₈ alkyl optionally interrupted by —O—, —S— or NR¹⁵—, C₅-C₁₂ cycloalkyl, C₆-C₁₄ aryl, or C₁-C₃ hydroxylalkyl; or R¹⁷ and R¹⁸ together with the N atom are a pyrrolidine, piperidine, piperazine, imidazole, or morpholine ring;
R¹⁹ is C₁-C₂₄ alkyl;
R²⁰ is C₁-C₂₄ alkyl, C₅-C₁₂ cycloalkyl, C₇-C₁₅ aryl, or C₇-C₁₅ aralkyl,
wherein the aralkyl and aryl are optionally substituted on the aryl ring by 1, 2, or 3 C₁-C₄ alkyl; the C₁-C₂₄ alkyl is optionally substituted by one or more —OH, —OC(O)R¹¹, —OR¹⁴, —Si(OCH₃)₃, —SH; or the C₁-C₂₄ alkyl is optionally interrupted by one or more —O—, —S—, or mixtures thereof and optionally substituted by one or more —OH or —OR¹⁵ groups or mixtures thereof; or
R²⁰ is a polymer chain substituted by one or more -SH, OH, OR¹⁴, OC(O)R¹¹, or —NHR¹⁴ and optionally interrupted by one or more —O—, —S—, or O(CO)— groups with a molecular weight of about 200 g/mol to about 4500 g/mol.

47. The oligomeric resin adduct of claim 46, wherein the oligomeric resin has a weight average molecular weight of about 500 to about 5000 g/mol.

48. The oligomeric resin adduct of claim 46, wherein the oligomeric resin adduct has a weight average molecular weight of about 550 to about 10,000 g/mol.

49. A printing ink, surface coating, chalk, sealant or overprint varnish comprising the oligomeric resin adduct of claim 46.
